(19) United States
(12) Patent Application Publication
(10) Pub. No.: US 2011/0007860 A1
(43) Pub. Date: Jan. 13, 2011

(54) Method and apparatus for reduction of neutron flux and or neutron containment, to facilitate nuclear-fusion

(75) Inventor: Frank Bernard Sanders, JR., Wayland, MI (US)

Correspondence Address: FRANK BERNARD SANDERS JR., 1572 138th Ave., Wayland, MI, 49348, US

(73) Assignee: Nathan Scott Sanders

(21) Appl. No.: 12/459,918

(22) Filed: Jul. 9, 2009

(51) Int. Cl. G21B 1/00

(52) U.S. Cl. 376/144

(57) ABSTRACT

A method and several embodiments of an apparatus for increasing reliability in IEC devices through ionization of a gas while imparting a non-radial momentum thereupon. Said non-radial momentum producing collisions between ionized particles and free neutrons generated from a point of nuclear fusion. Collisions are reduced between neutrons and apparatuses effecting temperatures in the vicinity of said point of nuclear fusion.

An electrical switching apparatus externally mounted to a cathode that encompasses an anode with an accelerator cage being disposed in-between. Said accelerator cage being electrically connected to said electrical switching apparatus.

### CROSS-REFERENCE TO RELATED APPLICATIONS

Not Applicable.

### FEDERAL SPONSORED RESEARCH

Not Applicable.

### SEQUENCE LISTING OR PROGRAM

Not Applicable.

### BACKGROUND

1. Field

This application relates to devices for generating nuclear-fusion reactions; specifically to devices for creating controlled nuclear-fusion reactions that utilize the Inertial Electrostatic Confinement approach.

2. Prior Art

In generating nuclear-fusion reactions by way of Inertial Electrostatic Confinement (IEC), three prevalent geometries are employed. Two are in relation to a cylindrical or spherical nature. The remaining is of a contrarily polyhedron geometry. For deeper explanations and discussions of these approaches to IEC, several U.S. patents have in here been provided: P. T. Farnsworth U.S. Pat. No. 3,258,402 issued Jun. 28, 1966; P. T. Farnsworth U.S. Pat. No. 3,386,883 issued Jun. 4, 1968; Robert L. Hirsch U.S. Pat. No. 3,530,036 issued Sep. 22, 1970; Robert L. Hirsch
U.S. Pat. No. 3,533,910 issued Oct. 13, 1970; Robert L. Hirsch U.S. Pat. No. 3,530,497 issued Sep. 22, 1970, Robert W. Bussard U.S. Pat. No. 4,826,646 issued May 2, 1989; Robert W. Bussard U.S. Pat. No. 5,160,695 issued Nov. 3, 1992.

To date, no known approach to IEC has ever directly identified neutron flux as a specific issue. For purposes of understanding the broader aspects of IEC and the pertinence of neutron escape or flux thereto, the simpler spherical geometry will henceforth only be discussed. The following specific example of an IEC device was studied by William C. Elmore, James L. Tuck, and Kenneth M. Watson of Los Alamos Scientific Laboratory; University of California ca. 1959, and will suffice as a generalization of IEC and this neutron issue.

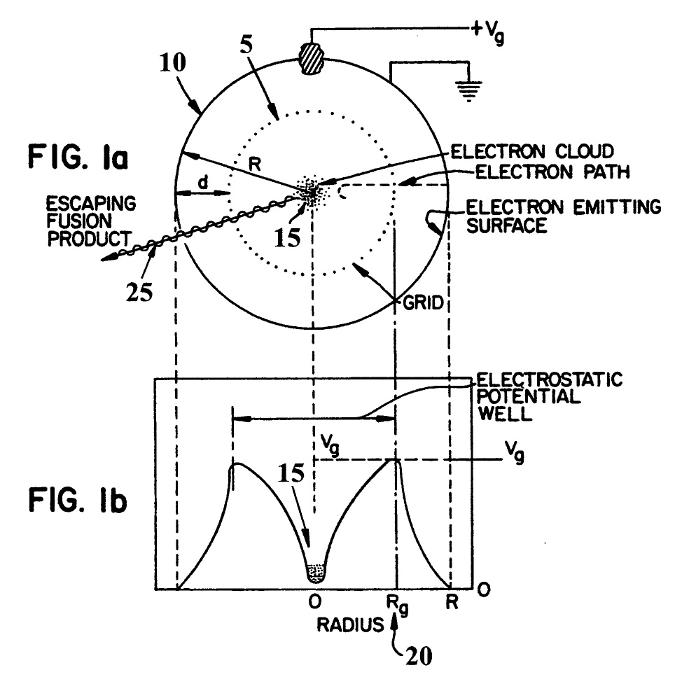

IEC utilizes two commonly known apparatuses to initiate nuclear-fusion reactions, an anode, and a cathode. Referring to FIG. 1A, an IEC device is shown with a spherical anode 5 that is highly permeable to charged particle flow concentrically placed inside of a spherical cathode 10 that is not. Spherical cathode 10 has a dual purpose; it serves as the shell of an evacuated chamber and also as an electron source. When energized at a higher potential than spherical cathode 10, spherical anode 5 pulls electrons radially from the inner surface of spherical cathode 10, across or “through” space, toward spherical anode 5. This electron transit occurs due to the difference in potential charges. Since spherical anode 5 is highly permeable to charged particle flow, it allows a large percentage of transiting electrons to concentrically converge inside the volume it encompasses. As electrons approach this “focal point” they begin to lose their velocity, and for purposes of a simplified explanation, nearly stop in this vicinity due to the likeness of their charge. This creates a highly negative space charge region sometimes referred to as a negative potential well 15; where at its center, an electrostatic potential develops that is close to the energy applied to spherical anode 5. FIG. 1B shows this distribution.

The purpose behind creating negative potential well 15 is to capture positive ions that are later introduced into the system at the edge of spherical anode 5. These ions then begin to oscillate along a radius 20 of negative potential well 15, colliding with each other as they attempt to reach the “bottom” where the potential difference in charge is greatest. Some of these oscillating ions are accelerated at sufficient velocities to undergo nuclear-fusion reactions, while others undergo scattering reactions because of their palpable lack of velocity. However, most of the ions that do undergo scattering reactions are not lost; these reactions take place at, or very near, the “bottom” of negative potential well 15. Most of said ions are merely redirected in a different radial path without sufficient momentum to escape. This inference of course assumes perfect head-on collisions between scattering ions.

For positive ions that do attain sufficient reaction velocities, one resulting product is a free neutron 25. This sub-atomic particle is ejected outwardly on a radial trajectory from the point at which a nuclear-fusion reaction takes place. Because of its inherently neutral net charge, free neutron 25 is electrically uninfluenced by negative potential well 15, along with any constant or variable inverse charge it may encounter. Therefore any ion or atom impeding its trajectory will result in a physical collision, causing either scattering, absorption, or in some cases capture of free neutron 25. And although a neutron (free or otherwise) possesses a magnetic moment, it seems to be of a non-issue in IEC since an abundance of free neutrons are always detected outside of the encompassing volume of cathode 10 when an IEC device is in operation. Of a more important note however, is the detection of any free neutron beyond the confines of an operating IEC device. Such detection is widely regarded as scientific proof for the occurrence of a nuclear-fusion reaction.

In the case of atomic interactions with a free neutron, a fourth possibility of atomic ionization can occur. When a free neutron strikes the nucleus of a rest atom at certain vectors, the atom itself can be displaced within the molecular structure of its element due to the law of conservation of linear momentum. When this possibility actually occurs, the atomic nucleus of the incident atom recoils from the impact of said neutron, dislodging it from the electron cloud it inhabits; thus destroying its covalent bond and creating what is called an ionization of the atom. This ionized atom, or atomic nucleus, then collides with other atoms within its vicinity transferring its kinetic energy. These secondary atomic collisions can then cause further ionization and so forth until the initial kinetic energy from an incident neutron is satisfactorily converted. This is a major contributor to the degradation and radioactivity observed in all apparatuses crucial to the perpetuation of nuclear-fusion reactions through the employ of IEC.

One known approach to resolving this issue involves the choice of nuclear fuel. Depending upon the elemental and isotopic nature of the reacting ions, neutron energies vary. There are also certain initial reaction equations that allude to a neutron free product. One such example of this is:

ρ+¹¹B→3 ⁴He

where ρ represents a Proton, ¹¹B represents an isotope of the element Boron, and ⁴He an isotope of the element Helium. The answer in this equation is essentially three α (Alpha) particles that are easily converted into ⁴He by either an electric field, or through the stripping away of two electrons from an incident atom, or atoms, through atomic interactions.

A draw-back to this nuclear-fusion reaction, and to others of the like, lies somewhat within the required initiation energies; they are significantly greater than those required for any contrasting lighter nuclei. This can result in additional cost and even complexity for an IEC device from an engineering aspect. If higher energies are required, than respectively some apparatuses must be re-engineered to safely accommodate such energies. Expanding pursuant to this logic, design of new apparatuses may be required to prevent failure of some or all apparatuses in such an IEC system; thus contributing to increasing the complexity of such a device.

Another inherent issue also arises from the aforementioned equation in the fact that some secondary side-reactions, such as:

⁴He+¹¹B→n+N¹⁴

where ⁴He represents an isotope of the element Helium, ¹¹B represents an isotope of the element Boron, n represents a Neutron, and N¹⁴ represents an isotope of the element Nitrogen, emphatically do produce neutrons; may they be at a substantially lower occurrence. Such fuel selection approaches do not completely resolve the aforementioned degradation and radioactivity issues. What they do provide however, is a reprieve to eventual failure of all apparatuses in any known IEC device. With all aforementioned aspects taken into account, ideally what is lacking is a method and apparatus to confine neutrons generated by an IEC device to a spatial area that negates the possibility of neutron interaction with all apparatuses of such a device.

### SUMMARY

For sake of improving reliability in IEC devices, several embodiments herein are disclosed of a novel method and apparatus for reduction of neutron flux and or the containment of free neutrons. The aforementioned embodiments consist of a generally spherically shaped hollow anode, highly permeable to charged particle flow, encompassed by a generally spherically shaped and impermeable cathode. Said cathode also functions as the shell of an evacuated chamber. Between said cathode and said anode, disposed is a plurality of electrically conductive rod or wire in a configuration as to resemble the shape of a generally spherical accelerator cage. Said accelerator cage is also highly permeable to charged particle flow. An electrical switching apparatus is provided as well as a means for application of electrical potentials to all electrically conductive apparatuses. Means are also provided for the generation of positive ions from a reactant gas, as well as means for the creation of a generally spherical rotating positive ion flow. Furthermore means are provided for causing collisions between neutrons, resulting from nuclear-fusion reactions produced by the aforementioned apparatuses, and said ions in the aforementioned generally spherical rotating positive ion flow.

### BRIEF DESCRIPTION OF THE DRAWINGS

The above-mentioned and other features of all apparatuses and means will become more apparent and best understood by referencing the following description of an embodiment in conjunction with the accompanying drawings, herein:

### DRAWINGS—Figures

FIG. 1a-1b are both prior art.

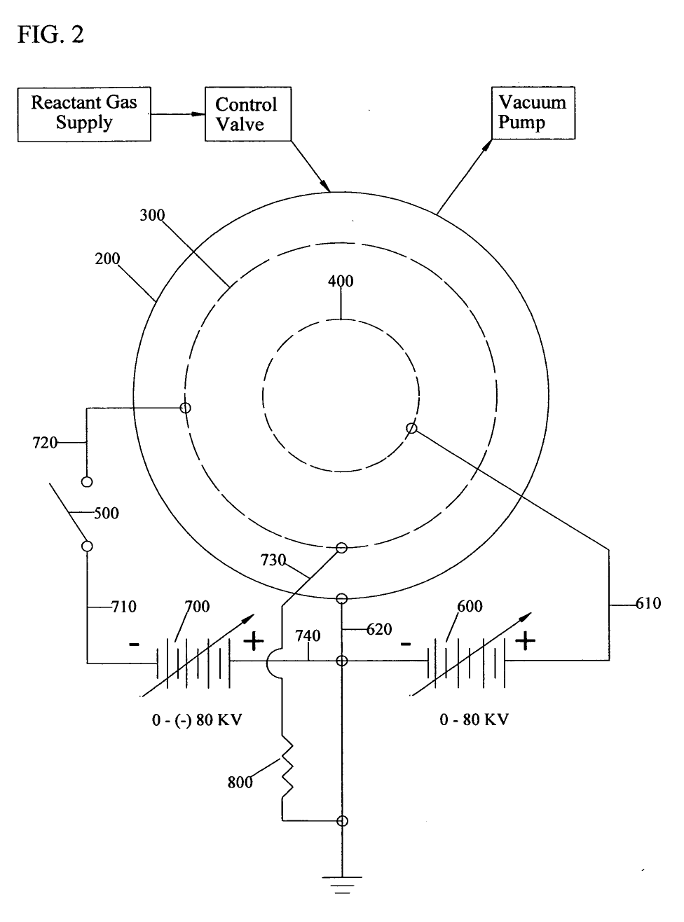

FIG. 2 shows a schematic depiction of a hermetically sealed spherical electron tube structure.

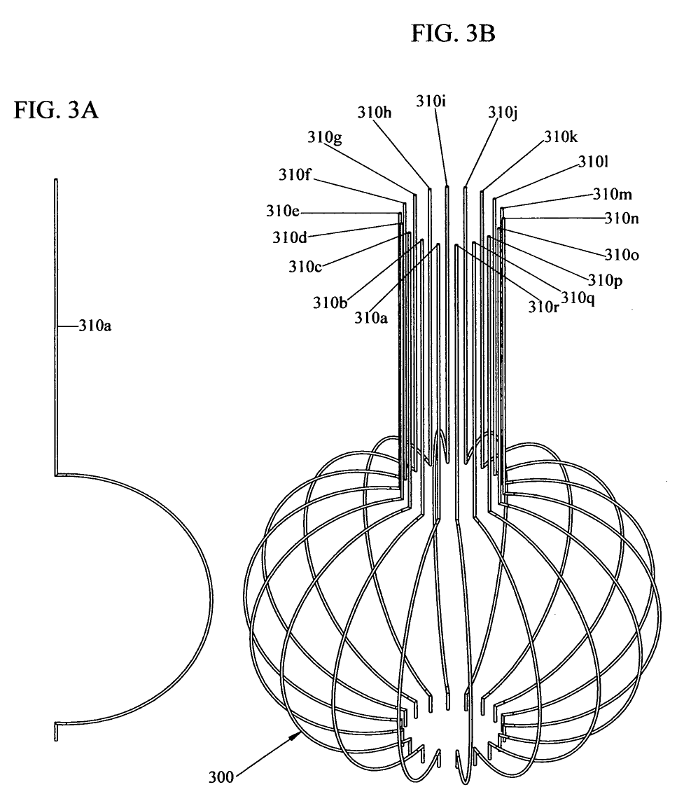

FIG. 3A shows a front view of an isolated electrically conductive rod or wire.

FIG. 3B shows an isometric view of a plurality of identical electrically conductive rod or wire in a configuration as to resemble a generally spherical cage.

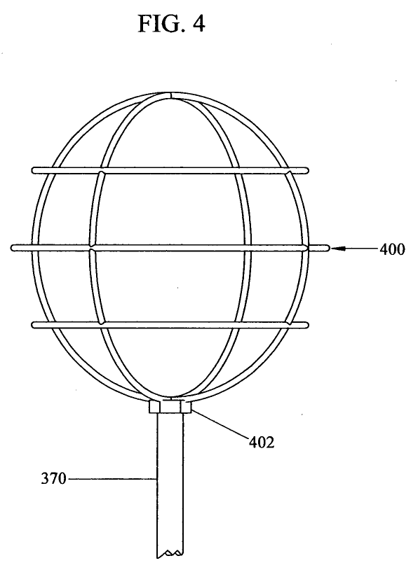

FIG. 4 shows a spherical anode.

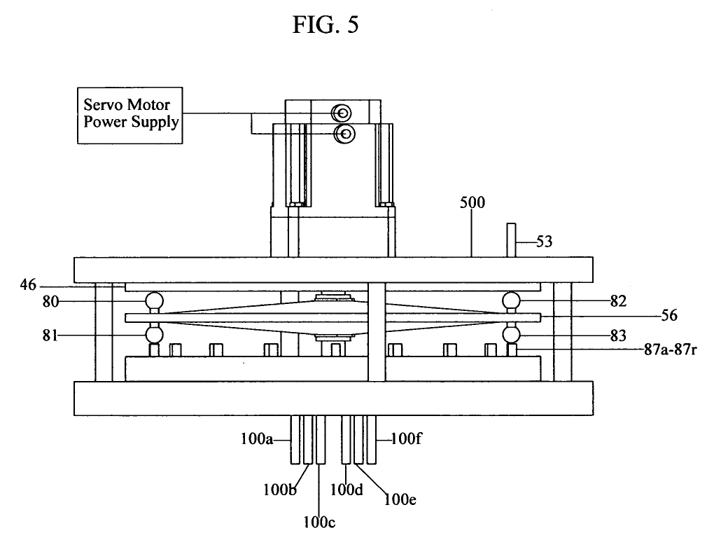

FIG. 5 shows a front view of an electrical switching apparatus.

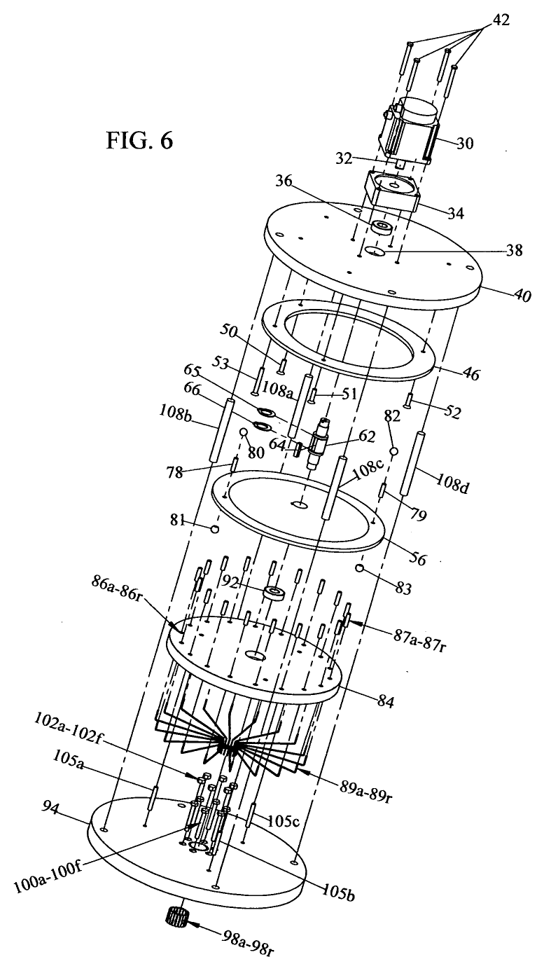

FIG. 6 shows an exploded view of an electrical switching apparatus.

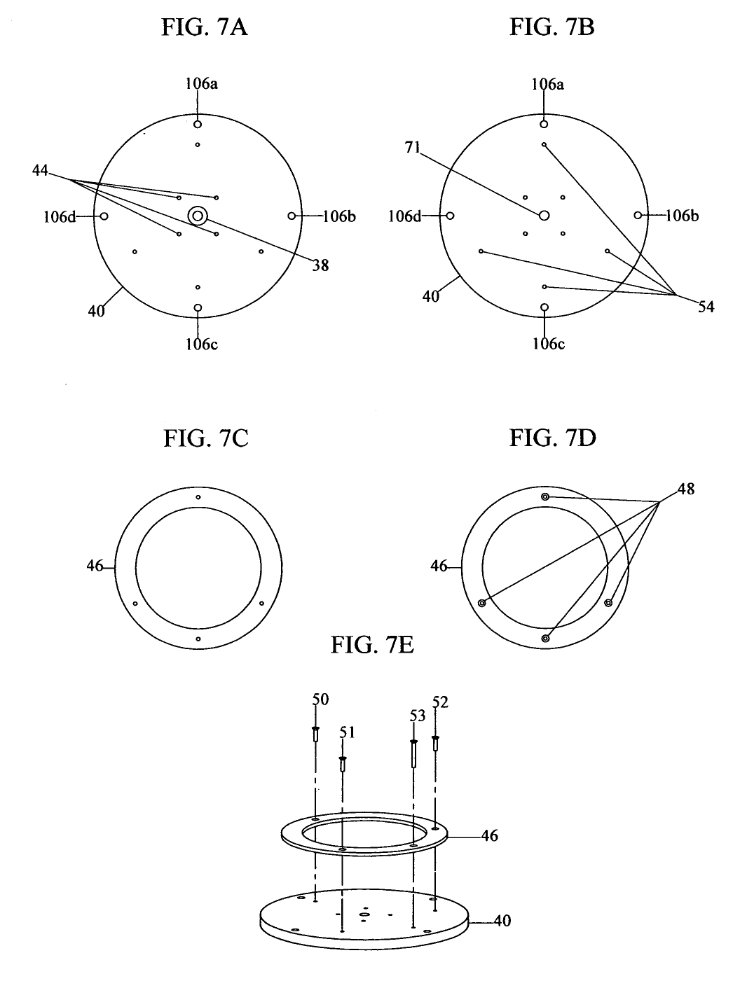

FIG. 7A shows a top view of a top base plate.

FIG. 7B shows a bottom view of a top base plate.

FIG. 7C shows a top view of a power transfer plate or ring.

FIG. 7D shows a bottom view of a power transfer plate or ring.

FIG. 7E illustrates a relationship between a power transfer plate or ring and a top base plate.

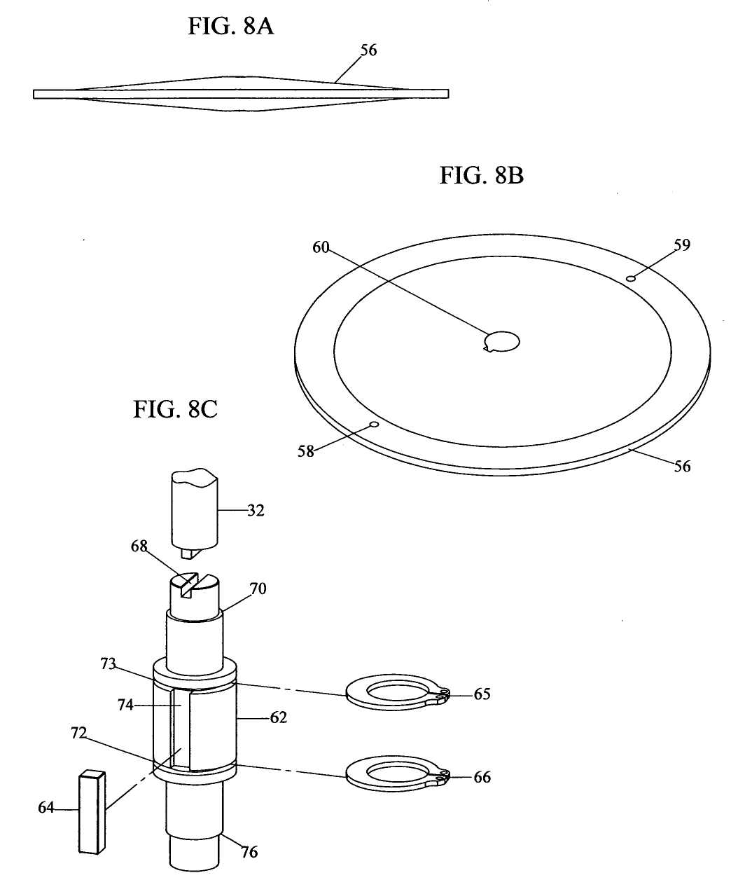

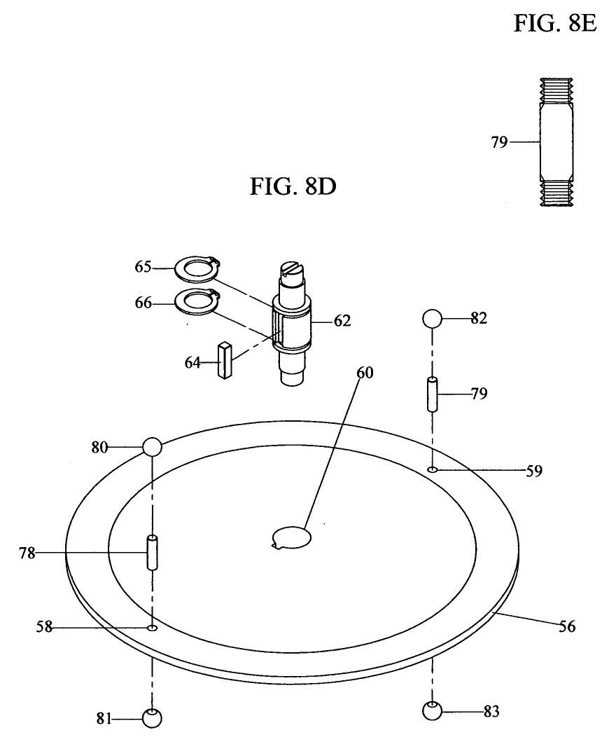

FIG. 8A shows a front view of a plate or disk.

FIG. 8B shows an isometric view of a plate or disk.

FIG. 8C shows an isometric view of a shaft, a key, and a set of keepers along with part of another shaft.

FIG. 8D shows a closer view of a plate or disk assembly.

FIG. 8E shows a more detailed view of a stud.

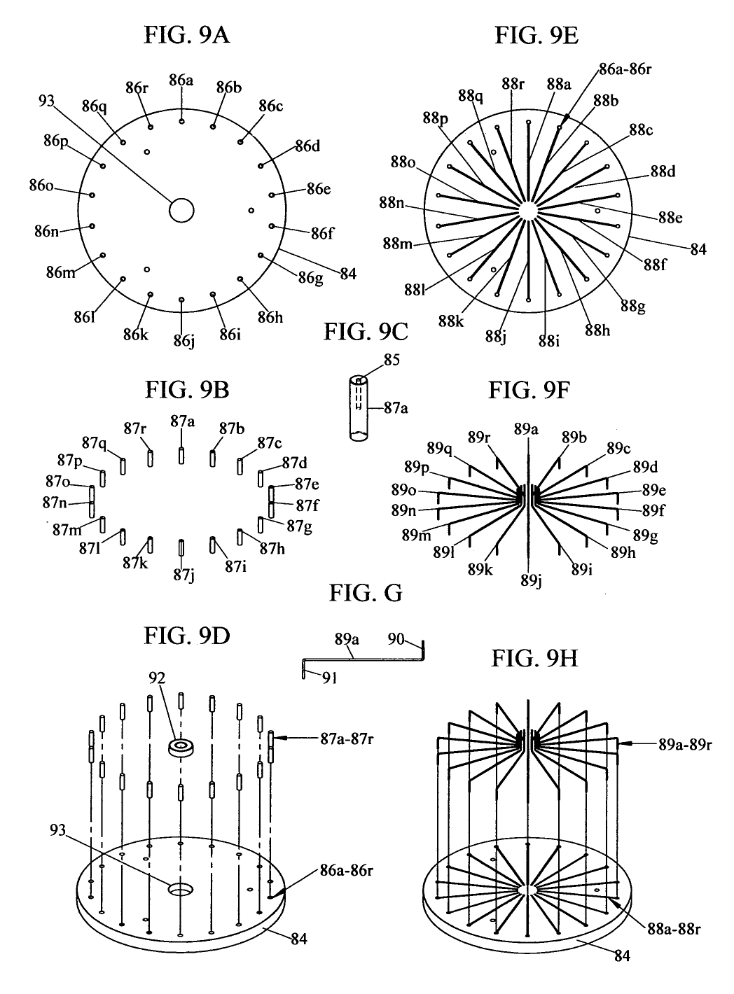

FIG. 9A shows a top view of a stud plate.

FIG. 9B shows an isometric view of a plurality of identical conductor or stud.

FIG. 9C shows a recess contained within the bottom face of a stud.

FIG. 9D illustrates a relationship between a set of studs, a bearing, and a stud plate.

FIG. 9E shows a bottom view of a stud plate.

FIG. 9F shows an isometric view of a plurality of electrical conductor or wire.

FIG. 9G shows a left side view of an electrical conductor or wire having bent end portions.

FIG. 9H illustrates a relationship between a plurality of conductor or wire and a stud plate.

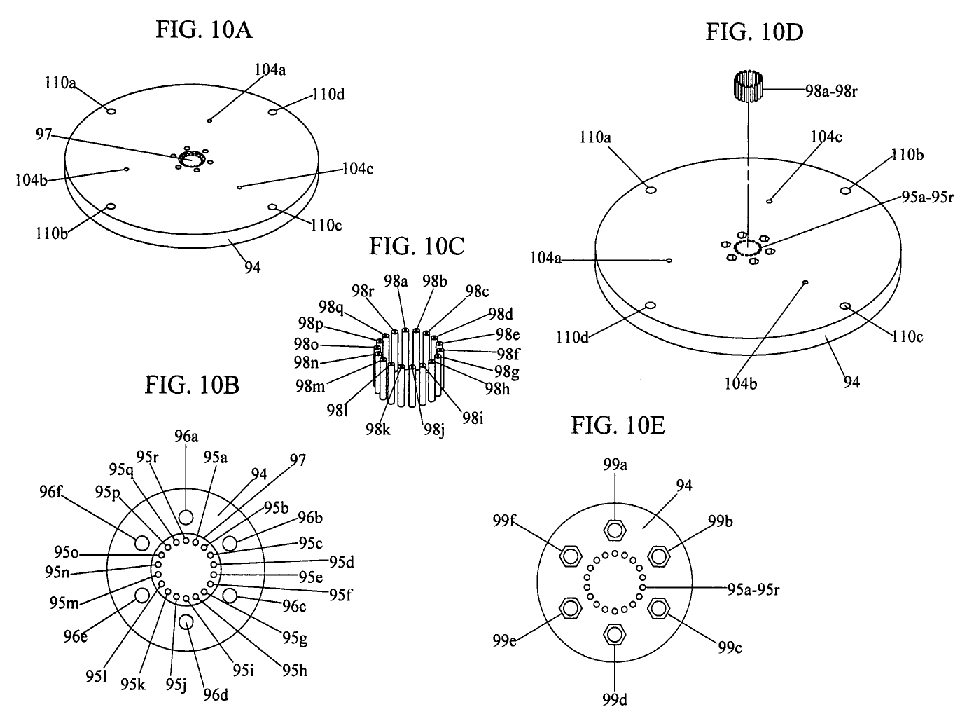

FIG. 10A shows an isometric bottom view of a bottom base plate.

FIG. 10B shows a detailed bottom view of a bottom base plate with a sunken area.

FIG. 10C shows a plurality of electrical connector.

FIG. 10D illustrates a relationship between a plurality of connector and a bottom base plate.

FIG. 10E shows a detailed top view of the center of a bottom base plate.

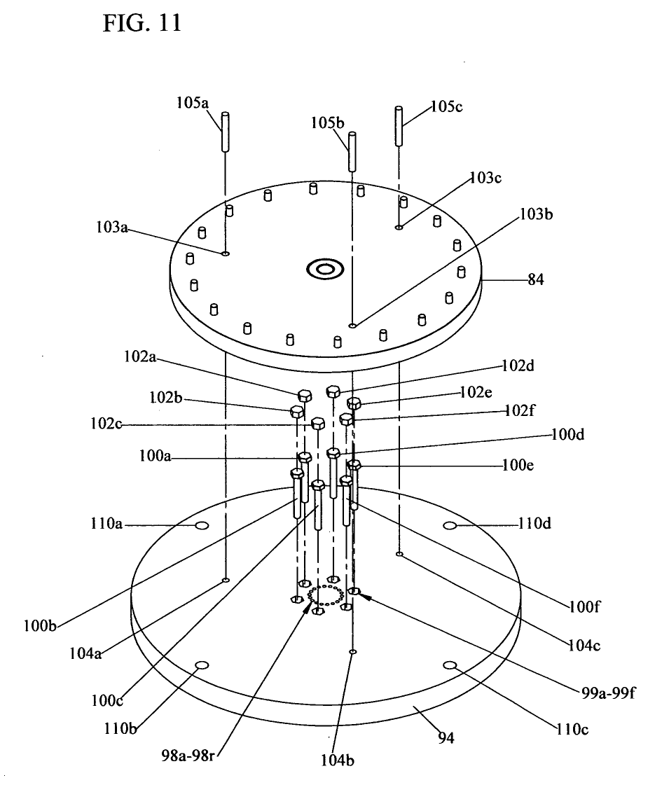

FIG. 11 illustrates a relationship between a stud plate and a bottom base plate.

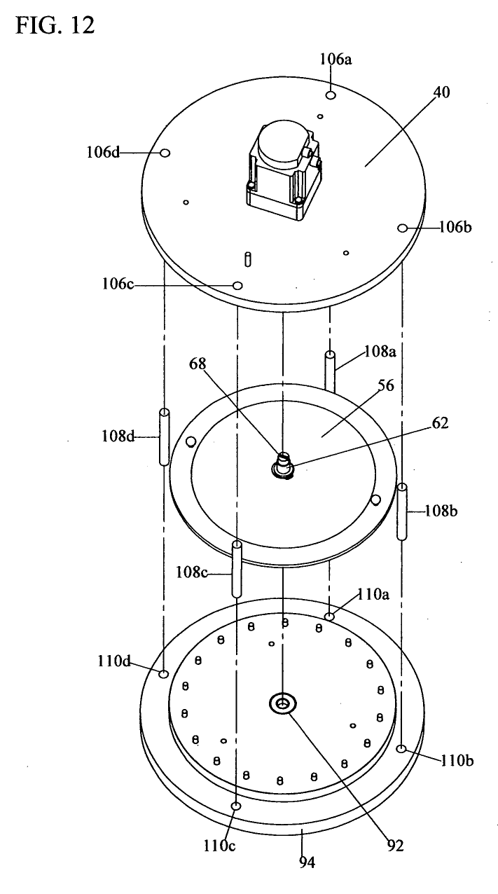

FIG. 12 illustrates a final assembly of an electrical switching apparatus.

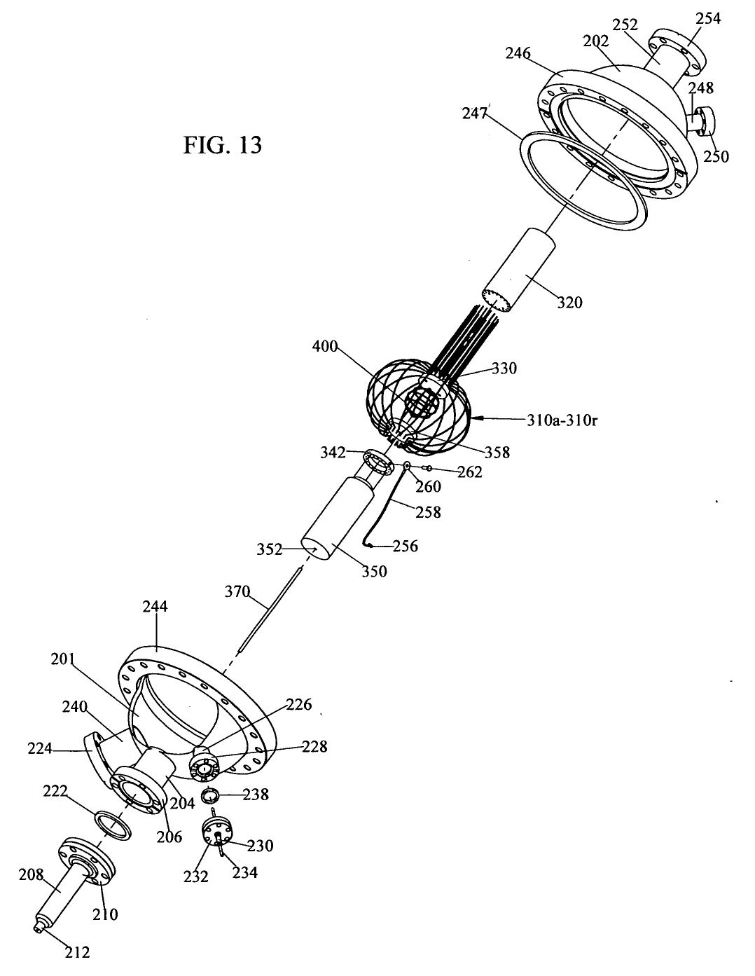

FIG. 13 shows an exploded view of a cathode and a spherical cage along with an anode.

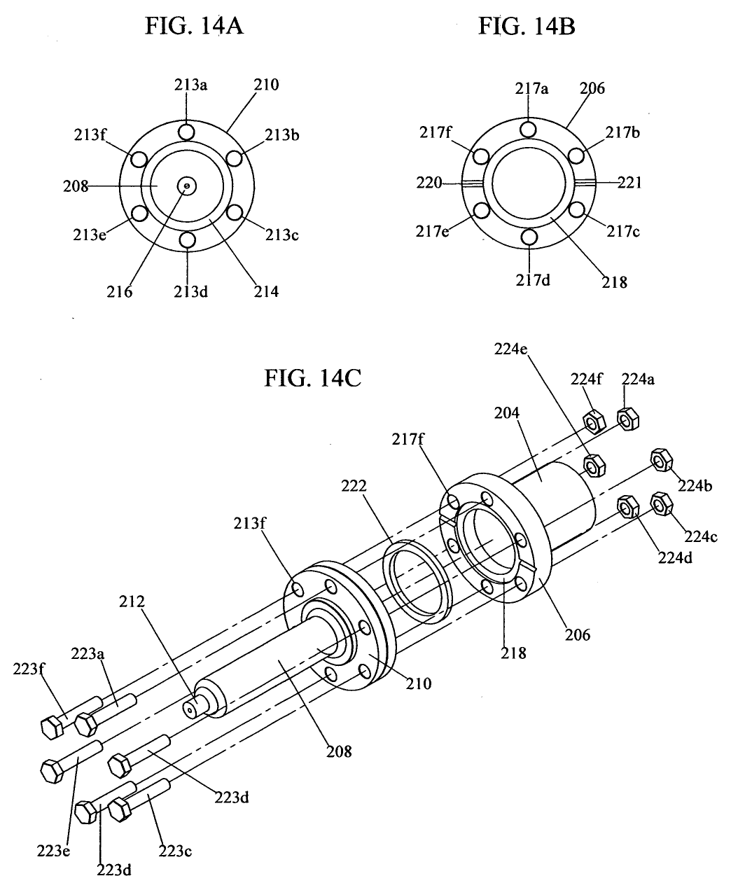

FIG. 14A shows a bottom view of an insulator having a flange.

FIG. 14B shows a front view of a flange.

FIG. 14C illustrates a relationship between an insulator and a conduit.

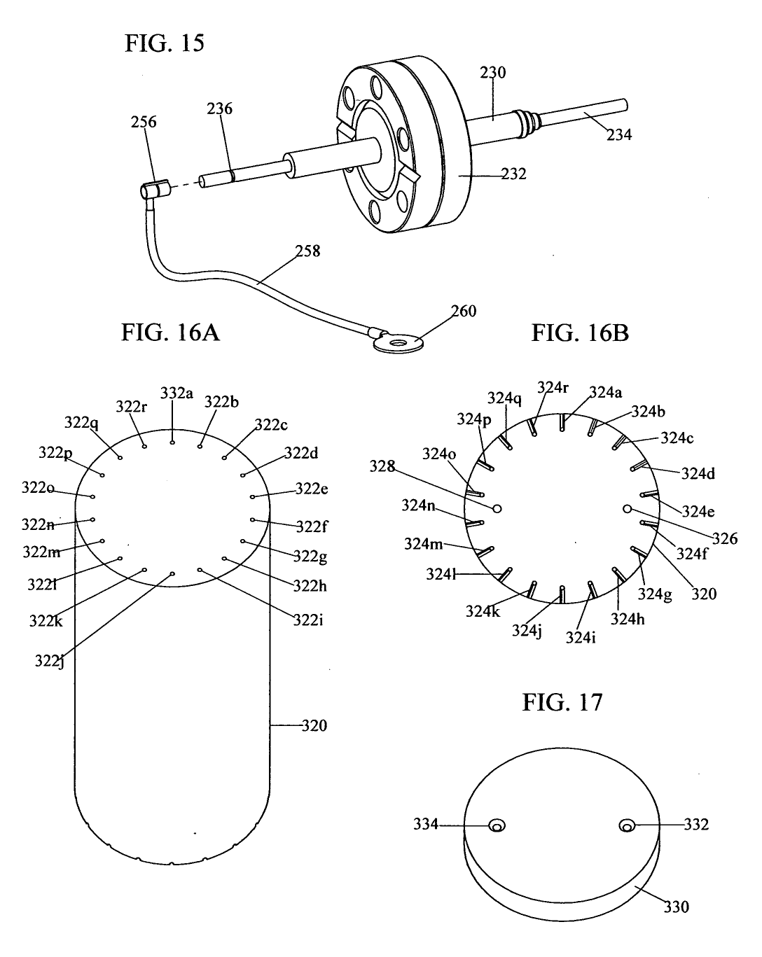

FIG. 15 shows a lateral isometric view of an insulator having a flange.

FIG. 16A shows a top isometric view of an insulator.

FIG. 16B shows a bottom view of an insulator.

FIG. 17 shows a bottom isometric view of a cap or covering.

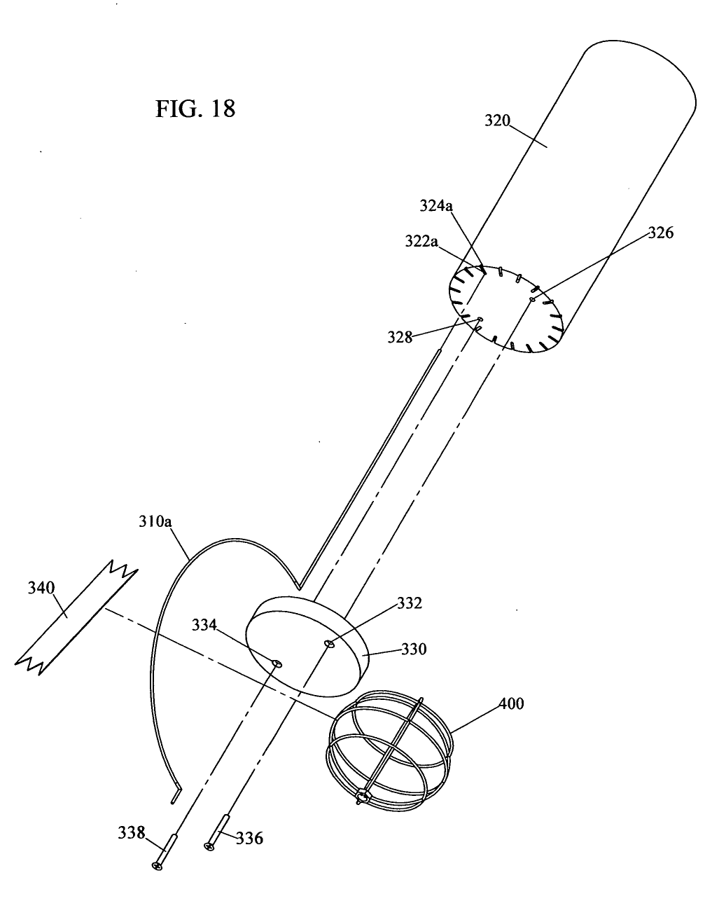

FIG. 18 illustrates a relationship between an insulator, an electrically conductive rod, a covering, and an anode.

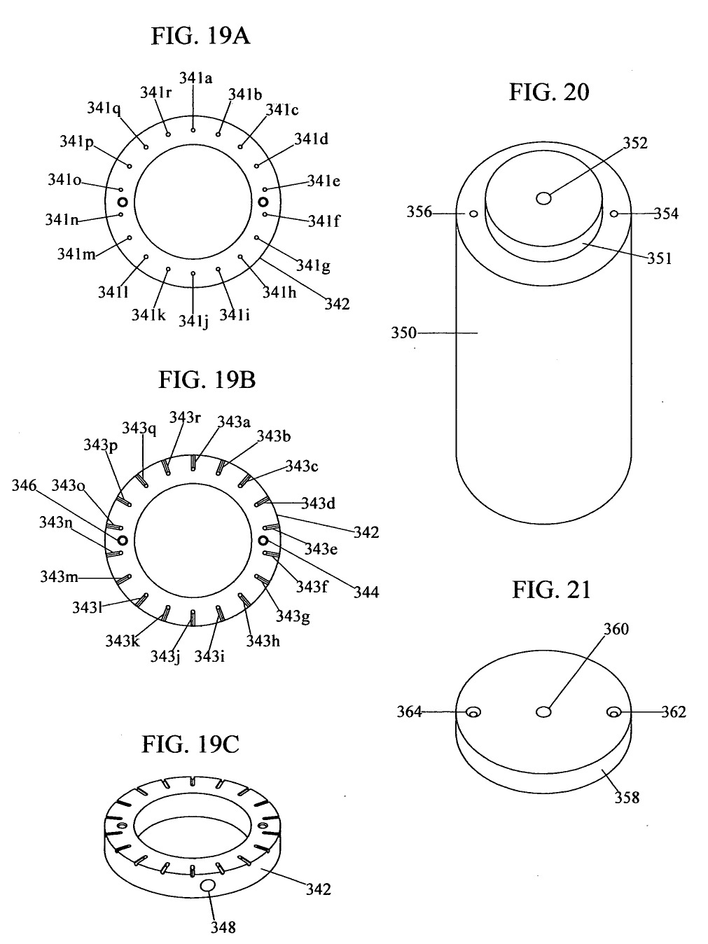

FIG. 19A shows a bottom view of an electrically conductive ring.

FIG. 19B shows a top view of an electrically conductive ring.

FIG. 19C shows a top isometric view of an electrically conductive ring having a threaded recess.

FIG. 20 shows a top isometric view of an insulator.

FIG. 21 shows a top isometric view of a cap or covering.

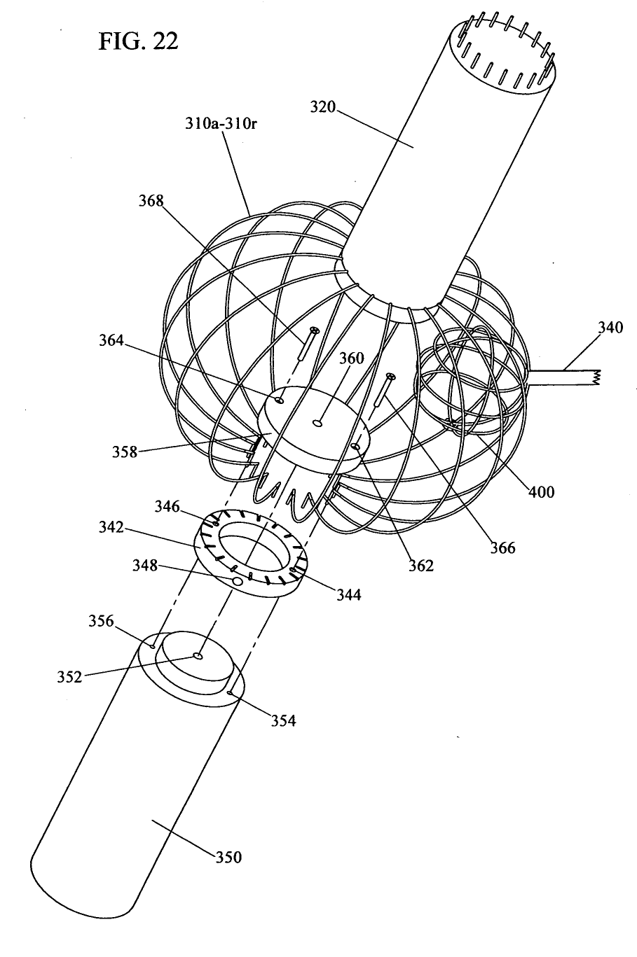

FIG. 22 illustrates a relationship between an electrically conductive ring, an insulator, a covering, and a plurality of electrically conductive rod.

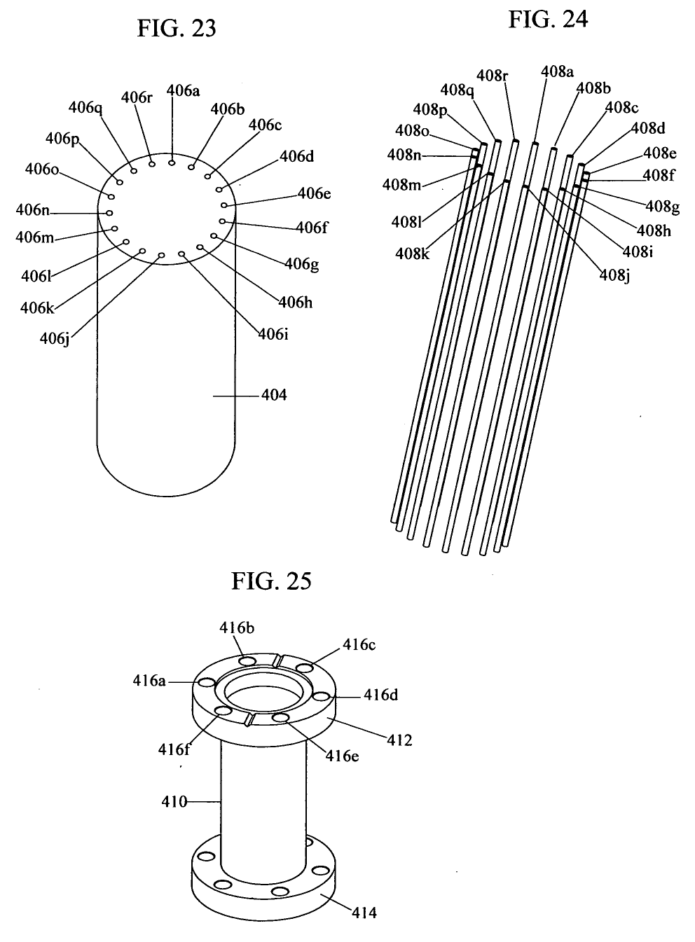

FIG. 23 shows a top isometric view of an insulator.

FIG. 24 shows a plurality of electrical connector.

FIG. 25 shows a top isometric view of a vacuum extension.

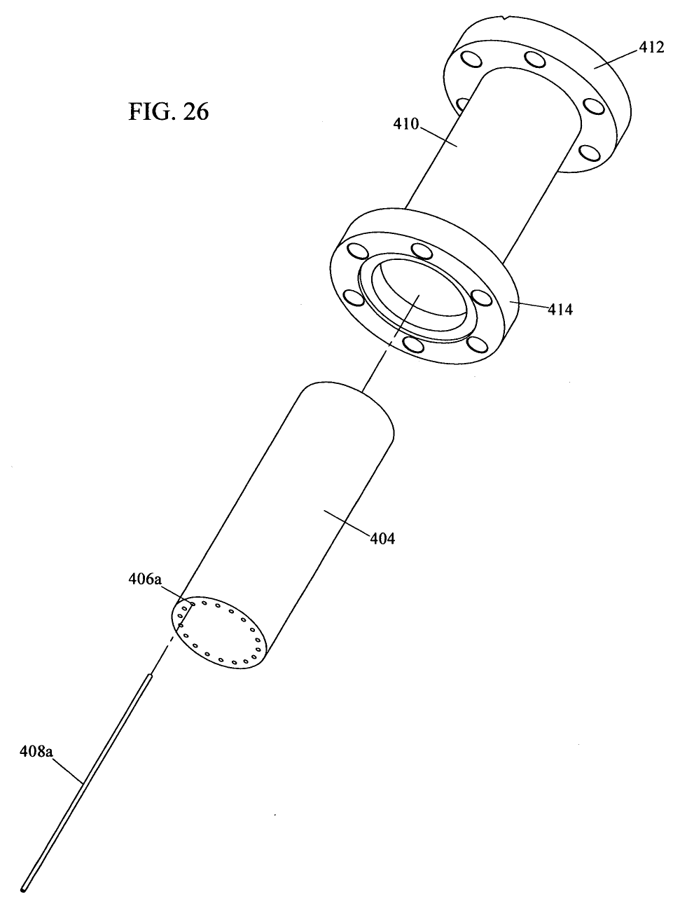

FIG. 26 illustrates a relationship between an electrical connector, an insulator, and a vacuum extension.

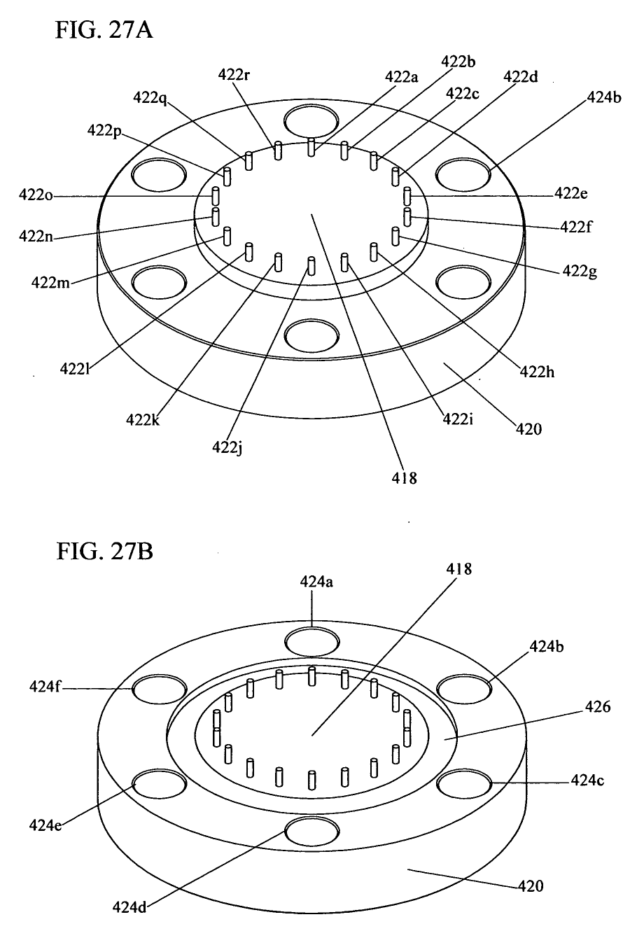

FIG. 27A shows a top isometric view of an electrical plug having a flange.

FIG. 27B shows a bottom isometric view of an electrical plug.

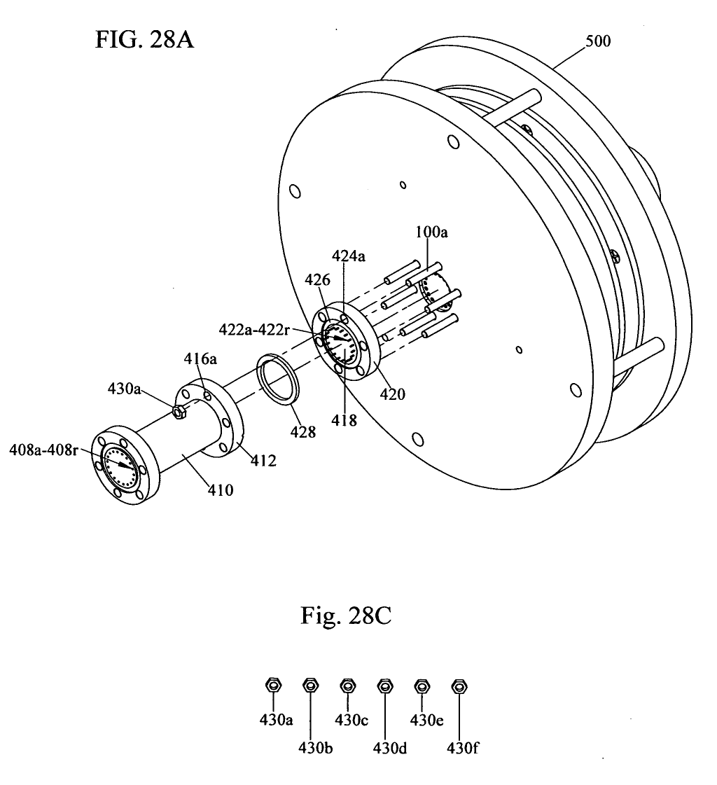

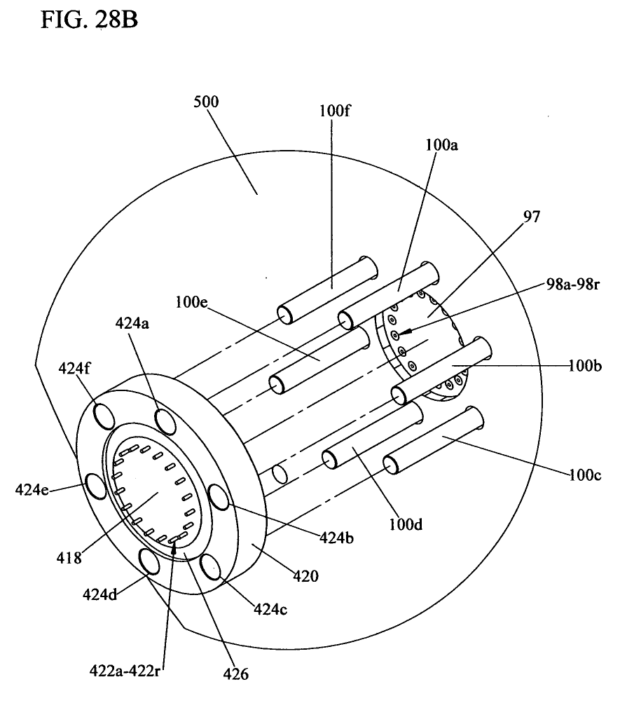

FIG. 28A illustrates a relationship between an electrical switching apparatus, an electrical plug, and a vacuum extension.

FIG. 28B shows a detailed view of an electrical plug and the bottom of an electrical switching apparatus.

FIG. 28C illustrates a plurality of threaded nut.

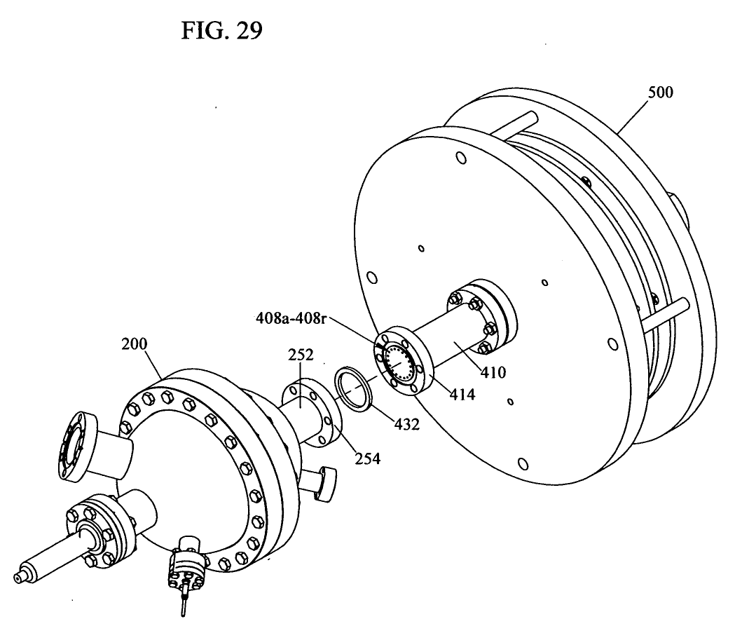

FIG. 29 illustrates a relationship between a conduit and a vacuum extension.

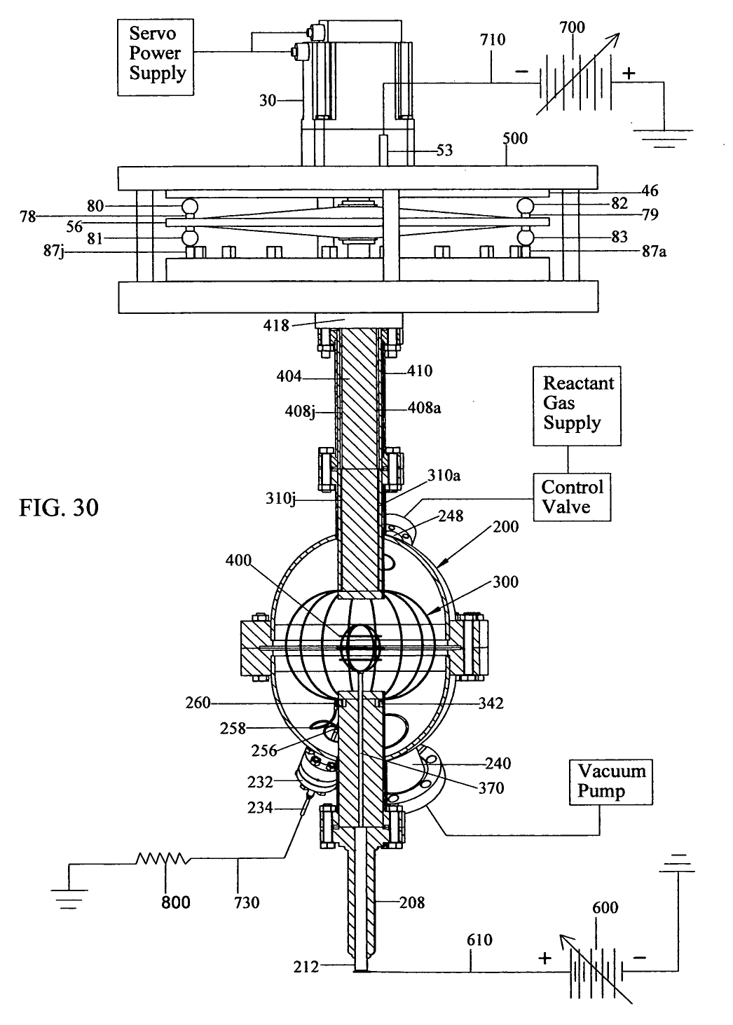

FIG. 30 shows a diagrammatic illustration of the first embodiment for use in explaining the operation thereof.

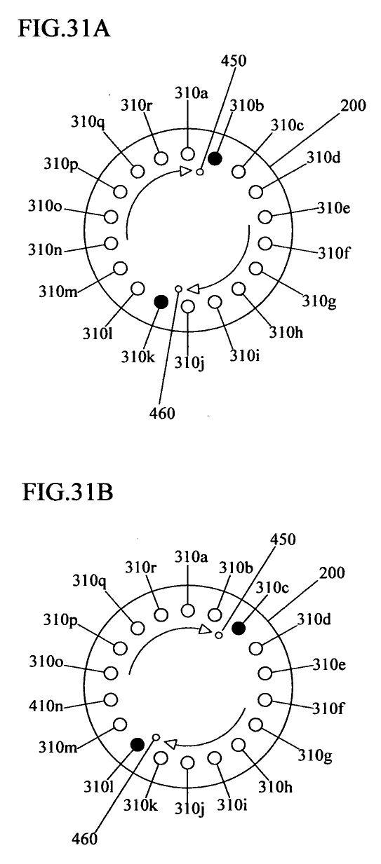

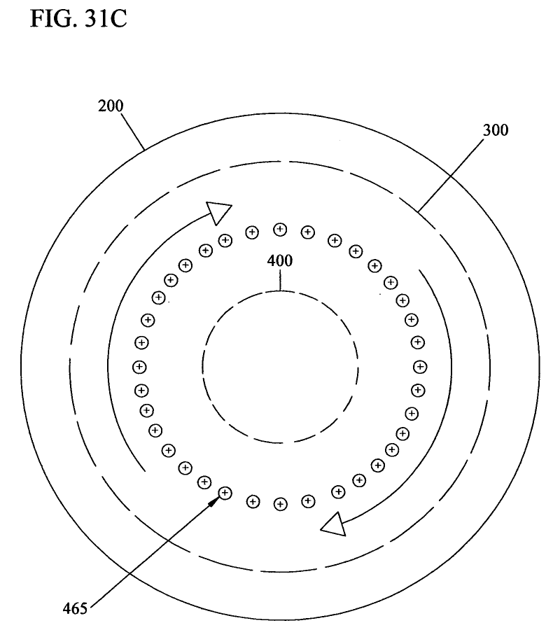

FIG. 31A illustrates an influence from a spherically rotating electric field upon a pair of positive ions.

FIG. 31B illustrates a progression in spatial position of a pair of positive ions.

FIG. 31C is a two dimensional representation of a generally spherical positive ion flow disposed between a cathode and an anode.

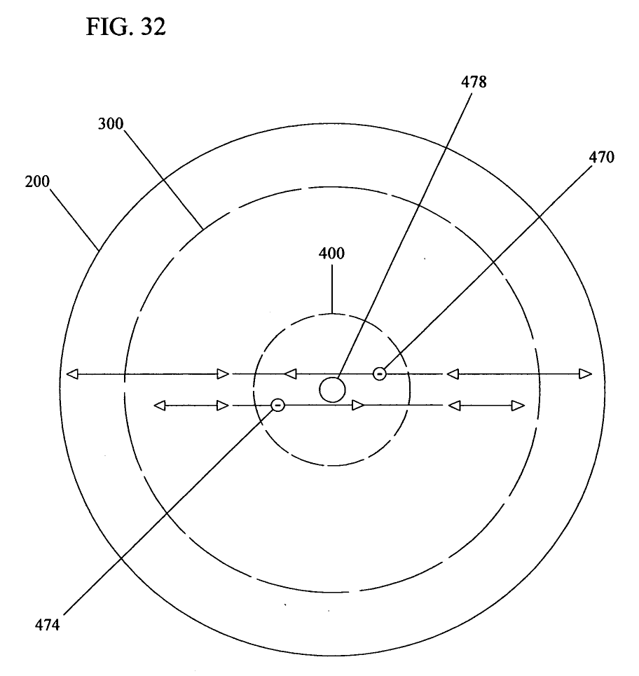

FIG. 32 diagrammatically illustrates an example of electron transit through the encompassed volume of an anode.

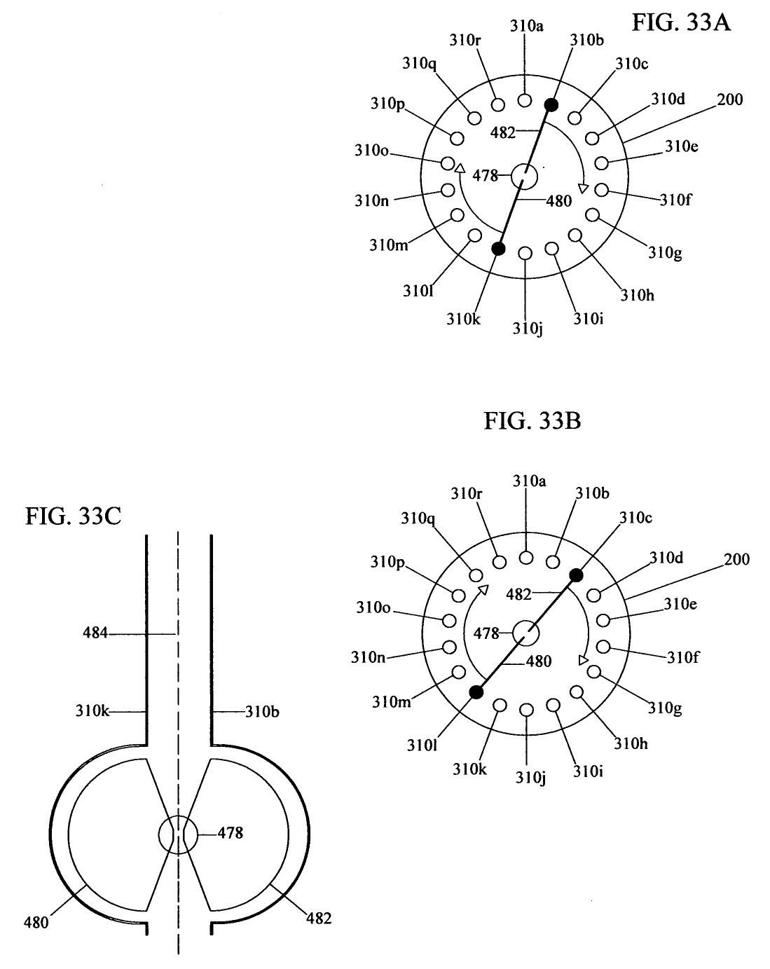

FIG. 33A illustrates an influence from a plurality of non-static electric field upon a virtual cathode.

FIG. 33B illustrates a progression of influence from a plurality of non-static electric field upon a virtual cathode.

FIG. 33C shows a two dimensional side view of a plurality of geometric plane depicting the affected sectors of a virtual cathode.

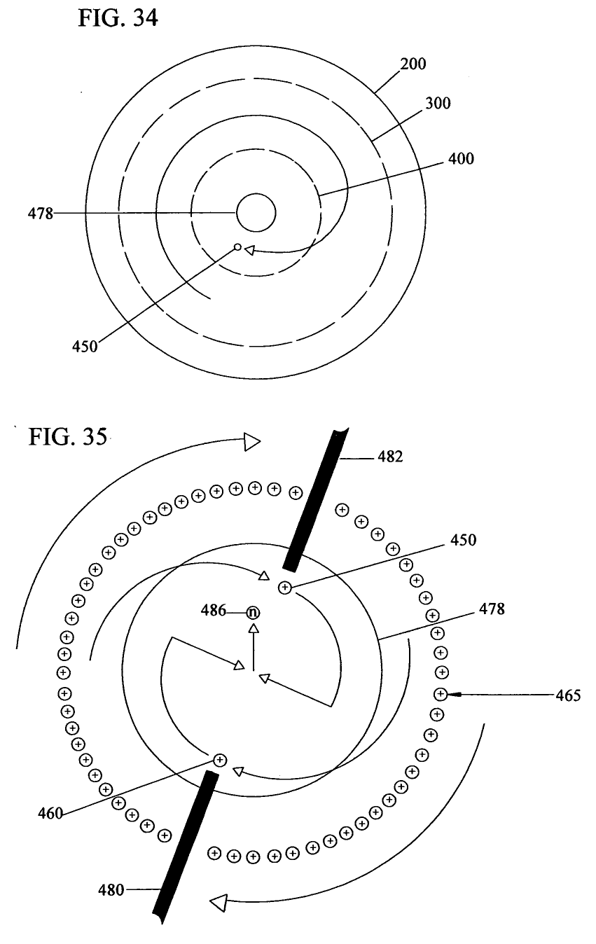

FIG. 34 shows a change in trajectory for a positive ion.

FIG. 35 shows a two dimensional detailed view of a virtual cathode as well as a generally spherical rotating positive ion flow in the reciprocation of this perception.

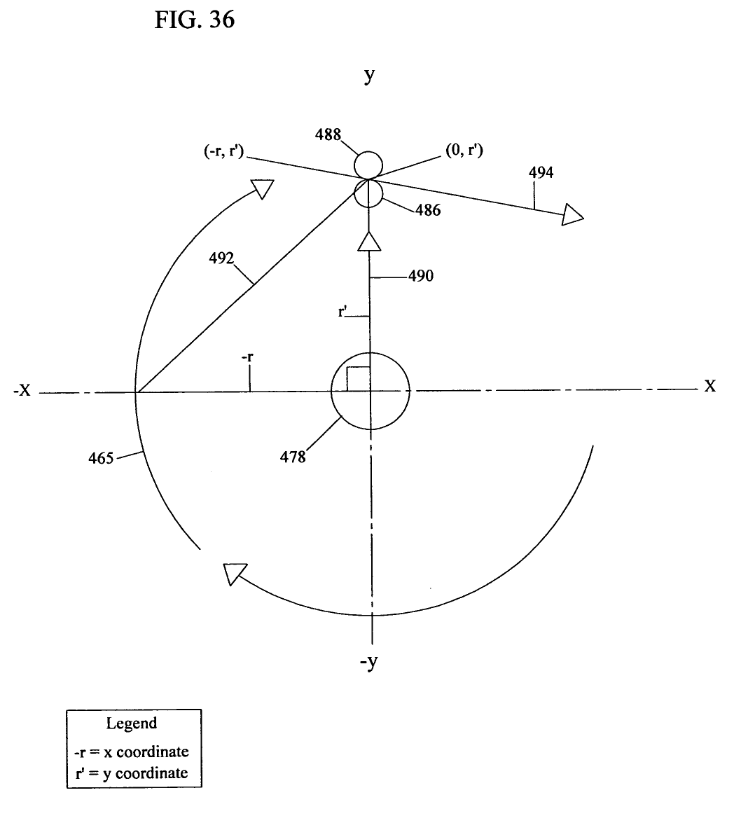

FIG. 36 shows a simple vector plot clarifying the scattering of a free neutron.

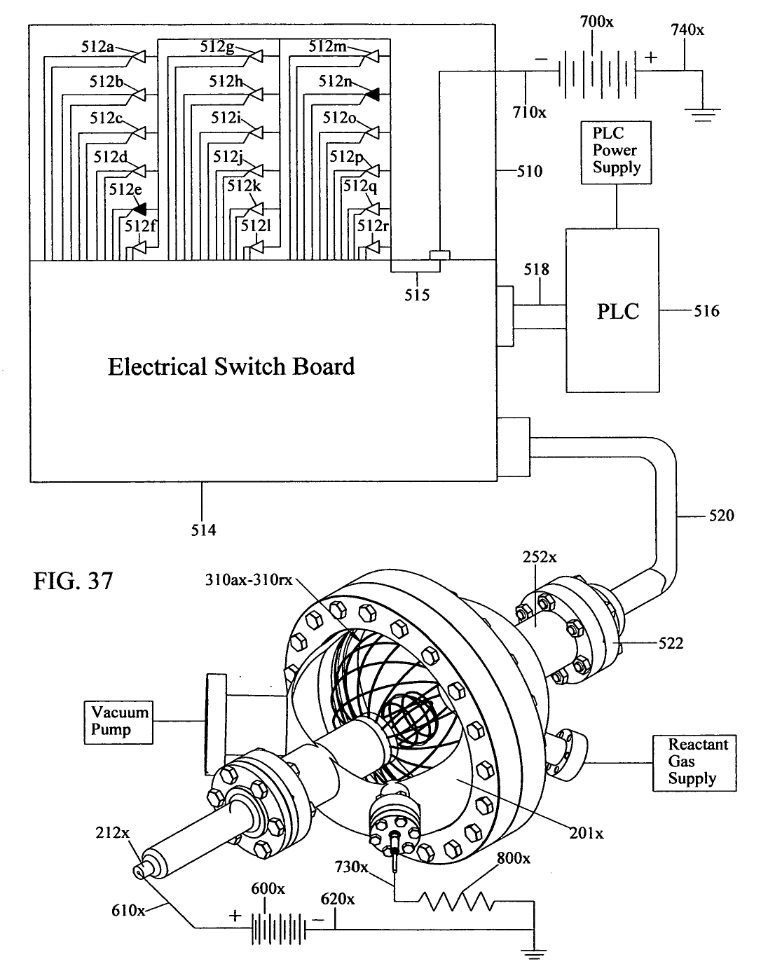

FIG. 37 shows a second embodiment of an electrical switching apparatus relating to an anode, a cathode, and an accelerator cage.

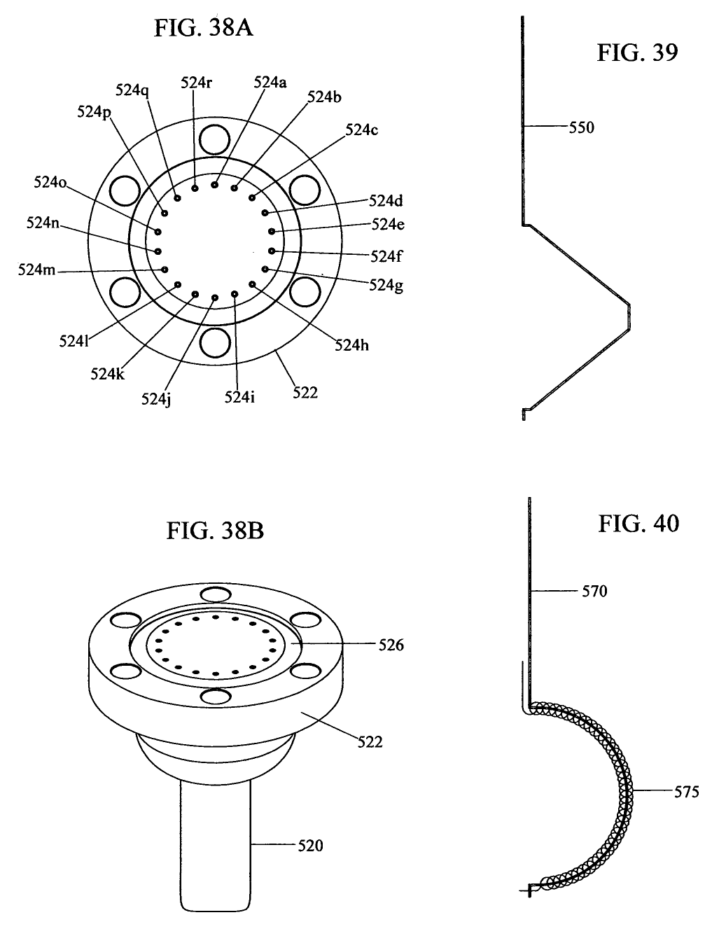

FIG. 38A shows a bottom view of an electrical plug relating to a second embodiment

FIG. 38B is a bottom isometric view of an electrical plug showing a contrarily tapered sunken area utilized in hermetic attachment relating to a second embodiment

FIG. 39 shows an electrically conductive rod relating to a third embodiment

FIG. 40 shows an electrically conductive rod having an electrically conductive wire relating to a fourth embodiment

### REFERENCE NUMERALS

### Prior Art

| | | | |
|---|---|---|---|
| 5 | anode | 10 | cathode |
| 15 | negative potential well | 20 | radius |
| 25 | free neutron | | |

### Embodiment

| | | | |
|---|---|---|---|
| 30 | servo motor | 32 | shaft |
| 34 | adapter | 36 | bearing |
| 38 | sunken area | 40 | top base plate |
| 42 | threaded bolts | 44 | threaded cavities |
| 46 | power transfer ring | 48 | tapered cavities |
| 50 | threaded and tapered screw | 51 | threaded and tapered screw |
| 52 | threaded and tapered screw | 53 | threaded and tapered screw |
| 54 | threaded holes | 56 | disk |
| 58 | cavity | 59 | cavity |
| 60 | cavity | 62 | shaft |
| 64 | key | 65 | keeper |
| 66 | keeper | 68 | female tang |
| 70 | Lip | 71 | cavity |
| 72 | groove | 73 | groove |
| 74 | keyway | 76 | lip |
| 78 | stud | 79 | stud |
| 80 | conductor | 81 | conductor |
| 82 | conductor | 83 | conductor |
| 84 | stud plate | 85 | recess |
| 86a | cavity | 86b | cavity |
| 86c | cavity | 86d | cavity |
| 86e | cavity | 86f | cavity |
| 86g | cavity | 86h | cavity |
| 86i | cavity | 86j | cavity |
| 86k | cavity | 86l | cavity |
| 86m | Cavity | 86n | cavity |
| 86o | cavity | 86p | cavity |
| 86q | cavity | 86r | cavity |
| 87a | stud | 87b | stud |
| 87c | stud | 87d | stud |
| 87e | stud | 87f | stud |
| 87g | stud | 87h | stud |
| 87i | stud | 87j | stud |
| 87k | stud | 87l | stud |
| 87m | stud | 87n | stud |
| 87o | stud | 87p | stud |
| 87q | stud | 87r | stud |
| 88a | groove | 88b | groove |
| 88c | groove | 88d | groove |
| 88e | groove | 88f | groove |
| 88g | groove | 88h | groove |
| 88i | groove | 88j | groove |
| 88k | groove | 88l | groove |
| 88m | groove | 88n | groove |
| 88o | groove | 88p | groove |
| 88q | groove | 88r | groove |
| 89a | wire | 89b | wire |
| 89c | wire | 89d | wire |
| 89e | wire | 89f | wire |
| 89g | wire | 89h | wire |
| 89i | wire | 89j | wire |
| 89k | Wire | 89l | wire |
| 89m | wire | 89n | wire |
| 89o | wire | 89p | wire |
| 89q | wire | 89r | wire |
| 90 | end portion | 91 | end portion |
| 92 | bearing | 93 | sunken area |
| 94 | bottom base plate | 95a | cavity |
| 95b | cavity | 95c | cavity |
| 95d | cavity | 95e | cavity |
| 95f | cavity | 95g | cavity |
| 95h | cavity | 95i | cavity |
| 95j | cavity | 95k | cavity |
| 95l | cavity | 95m | cavity |
| 95n | cavity | 95o | cavity |
| 95p | cavity | 95q | cavity |
| 95r | cavity | 96a | cavity |
| 96b | cavity | 96c | cavity |
| 96d | cavity | 96e | cavity |
| 96f | cavity | 97 | sunken area |
| 98a | electrical connector | 98b | electrical connector |
| 98c | electrical connector | 98d | electrical connector |
| 98e | electrical connector | 98f | electrical connector |
| 98g | electrical connector | 98h | electrical connector |
| 98i | electrical connector | 98j | electrical connector |
| 98k | electrical connector | 98l | electrical connector |
| 98m | electrical connector | 98n | electrical connector |
| 98o | electrical connector | 98p | electrical connector |
| 98q | electrical connector | 98r | electrical connector |
| 99a | sunken area | 99b | sunken area |
| 99c | sunken area | 99d | sunken area |
| 99e | sunken area | 99f | sunken area |
| 100a | threaded bolt | 100b | threaded bolt |
| 100c | threaded bolt | 100d | threaded bolt |
| 100e | threaded bolt | 100f | threaded bolt |
| 102a | cap | 102b | cap |
| 102c | cap | 102d | cap |
| 102e | cap | 102f | cap |
| 103a | cavity | 103b | cavity |
| 103c | cavity | 104a | cavity |
| 104b | cavity | 104c | cavity |
| 105a | dowel | 105b | dowel |
| 105c | dowel | 106a | cavity |
| 106b | cavity | 106c | cavity |
| 106d | cavity | 108a | dowel |
| 108b | dowel | 108c | dowel |
| 108d | dowel | 110a | cavity |
| 110b | cavity | 110c | cavity |
| 110d | cavity | 200 | cathode |
| 201 | hemisphere | 202 | hemisphere |
| 204 | conduit | 206 | flange |
| 208 | insulator | 210 | flange |
| 212 | electrical conductor | 213a | cavity |
| 213b | cavity | 213c | cavity |
| 213d | Cavity | 213e | cavity |
| 213f | cavity | 214 | contrarily tapered sunken |
| | | | area |
| 216 | threaded recess | 217a | cavity |
| 217b | cavity | 217c | cavity |
| 217d | cavity | 217e | cavity |
| 217f | cavity | 218 | contrarily tapered sunken |
| | | | area |
| 220 | groove | 221 | groove |
| 222 | gasket | 223a | threaded bolt |
| 223b | threaded bolt | 223c | threaded bolt |
| 223d | threaded bolt | 223e | threaded bolt |
| 223f | threaded bolt | 224a | threaded nut |
| 224b | threaded nut | 224c | threaded nut |
| 224d | threaded nut | 224e | threaded nut |
| 224f | threaded nut | 226 | conduit |
| 228 | flange | 230 | insulator |
| 232 | flange | 234 | electrical conductor |
| 236 | groove | 238 | gasket |
| 240 | pipe | 242 | flange |
| 244 | flange | 246 | flange |
| 247 | gasket | 248 | pipe |
| 250 | flange | 252 | conduit |
| 254 | flange | 256 | electrical connector |
| 258 | electrically conductive wire | 260 | electrical connector |
| 262 | threaded bolt | 300 | accelerator cage |
| 310a | electrically conductive rod | 310b | electrically conductive rod |
| 310c | electrically conductive rod | 310d | electrically conductive rod |
| 310e | electrically conductive rod | 310f | electrically conductive rod |
| 310g | electrically conductive rod | 310h | electrically conductive rod |
| 310i | electrically conductive rod | 310j | electrically conductive rod |
| 310k | electrically conductive rod | 310l | electrically conductive rod |
| 310m | electrically conductive rod | 310n | electrically conductive rod |
| 310o | electrically conductive rod | 310p | electrically conductive rod |
| 310q | electrically conductive rod | 310r | electrically conductive rod |
| 320 | insulator | 322a | cavity |
| 322b | cavity | 322c | cavity |
| 322d | Cavity | 322e | cavity |
| 322f | cavity | 322g | cavity |
| 322h | cavity | 322i | cavity |
| 322j | cavity | 322k | cavity |
| 322l | cavity | 322m | cavity |
| 322n | cavity | 322o | cavity |
| 322p | cavity | 322q | cavity |
| 322r | cavity | 324a | groove |
| 324b | groove | 324c | groove |
| 324d | groove | 324e | groove |
| 324f | groove | 324g | groove |
| 324h | groove | 324i | groove |
| 324j | groove | 324k | groove |
| 324l | groove | 324m | groove |
| 324n | groove | 324o | groove |
| 324p | groove | 324q | groove |
| 324r | groove | 326 | threaded recess |
| 328 | threaded recess | 330 | covering |
| 332 | tapered cavity | 334 | tapered cavity |
| 336 | threaded and tapered screw | 338 | threaded and tapered screw |
| 340 | temporary fastener | 341a | cavity |
| 341b | cavity | 341c | cavity |
| 341d | cavity | 341e | cavity |
| 341f | cavity | 341g | cavity |
| 341h | cavity | 341i | cavity |
| 341j | cavity | 341k | cavity |
| 341l | cavity | 341m | cavity |
| 341n | cavity | 341o | cavity |
| 34lp | cavity | 341q | cavity |
| 341r | cavity | 342 | electrically conductive ring |
| 343a | groove | 343b | groove |
| 343c | groove | 343d | groove |
| 343e | groove | 343f | groove |
| 343g | groove | 343h | groove |
| 343i | groove | 343j | groove |
| 343k | groove | 343l | groove |
| 343m | groove | 343n | groove |
| 343o | groove | 343p | groove |
| 343q | groove | 343r | groove |
| 344 | chamfered cavity | 346 | chamfered cavity |
| 348 | threaded recess | 350 | insulator |
| 351 | raised area | 352 | cavity |
| 354 | threaded recess | 356 | threaded recess |
| 358 | covering | 360 | cavity |
| 362 | tapered cavity | 364 | tapered cavity |
| 366 | threaded and tapered screw | 368 | threaded and tapered screw |
| 370 | electrical conductor | 400 | anode |
| 402 | threaded nut | 404 | insulator |
| 406a | cavity | 406b | cavity |
| 406c | cavity | 406d | cavity |
| 406e | cavity | 406f | cavity |
| 406g | cavity | 406h | cavity |
| 406i | cavity | 406j | cavity |
| 406k | cavity | 406l | cavity |
| 406m | cavity | 406n | cavity |
| 406o | cavity | 406p | cavity |
| 406q | cavity | 406r | cavity |
| 408a | electrical connector | 408b | electrical connector |
| 408c | electrical connector | 408d | electrical connector |
| 408e | electrical connector | 408f | electrical connector |
| 408g | electrical connector | 408h | electrical connector |
| 408i | electrical connector | 408j | electrical connector |
| 408k | electrical connector | 408l | electrical connector |
| 408m | electrical connector | 408n | electrical connector |
| 408o | electrical connector | 408p | electrical connector |
| 408q | electrical connector | 408r | electrical connector |
| 410 | vacuum extension | 412 | flange |
| 414 | flange | 416a | cavity |
| 416b | cavity | 416c | cavity |
| 416d | cavity | 416e | cavity |
| 416f | cavity | 417a | cavity |
| 417b | cavity | 417c | cavity |
| 417d | cavity | 417e | cavity |
| 417f | cavity | 418 | electrical plug |
| 420 | flange | 422a | pin |
| 422b | pin | 422c | pin |
| 422d | pin | 422e | pin |
| 422f | pin | 422g | pin |
| 422h | pin | 422i | pin |
| 422j | pin | 422k | pin |
| 422l | pin | 422m | pin |
| 422n | pin | 422o | pin |
| 422p | pin | 422q | pin |
| 422r | pin | 424a | cavity |
| 424b | cavity | 424c | cavity |
| 424d | cavity | 424e | cavity |
| 424f | cavity | 426 | contrarily tapered sunken |
| | | | area |
| 428 | gasket | 430a | threaded nut |
| 430b | threaded nut | 430c | threaded nut |
| 430d | threaded nut | 430e | threaded nut |
| 430f | threaded nut | 432 | gasket |
| 450 | positive ion | 460 | positive ion |
| 465 | generally spherical rotating | 470 | electron |
| | positive ion low | | |
| 474 | electron | 478 | virtual cathode |
| 480 | plane | 482 | plane |
| 484 | axis | 486 | free neutron |
| 488 | positive ion | 490 | vector |
| 492 | vector | 494 | vector |
| 500 | electrical switching apparatus | 510 | solid state electrical |
| | | | switching apparatus |
| 512a | silicon controlled rectifier | 512b | silicon controlled rectifier |
| 512c | silicon controlled rectifier | 512d | silicon controlled rectifier |
| 512e | silicon controlled rectifier | 512f | silicon controlled rectifier |
| 512g | silicon controlled rectifier | 512h | silicon controlled rectifier |
| 512i | silicon controlled rectifier | 512j | silicon controlled rectifier |
| 512k | silicon controlled rectifier | 512l | silicon controlled rectifier |
| 512m | silicon controlled rectifier | 512n | silicon controlled rectifier |
| 512o | silicon controlled rectifier | 512p | silicon controlled rectifier |
| 512q | silicon controlled rectifier | 512r | silicon controlled rectifier |
| 514 | electrical switch board | 515 | electrical lead |
| 516 | programmable logic controller | 518 | electrical cable |
| 520 | electrical cable | 522 | electrical plug |
| 524a | female electrical connector | 524b | female electrical connector |
| 524c | female electrical connector | 524d | female electrical connector |
| 524e | female electrical connector | 524f | female electrical connector |
| 524g | female electrical connector | 524h | female electrical connector |
| 524i | female electrical connector | 524j | female electrical connector |
| 524k | female electrical connector | 524l | female electrical connector |
| 524m | female electrical connector | 524n | female electrical connector |
| 524o | female electrical connector | 524p | female electrical connector |
| 524q | female electrical connector | 524r | female electrical connector |
| 526 | contrarily tapered sunken area | 550 | electrically conductive rod |
| 570 | electrically conductive rod | 575 | electrically conductive wire |
| 600 | power supply | 610 | lead |
| 620 | lead | 700 | power supply |
| 710 | lead | 720 | connection |
| 730 | lead | 740 | lead |
| 800 | resister | | |

### DETAILED DESCRIPTION

### First Embodiment

### Introduction

In the spirit of full disclosure, the following first embodiment is organized into five sections:
1. Overview of entire system
2. Electrical Switching Apparatus
3. Cathode, Accelerator Cage, and Anode
4. Final assembly
5. Operation

### Overview of Entire System—FIG. 2, FIG. 3A-3B, FIG. 4, FIG. 5

Referring to FIG. 2, a schematic depiction of a hermetically sealed electron tube structure is shown having a generally spherical cathode 200. Cathode 200 is comprised of an electrically conductive material (e.g. stainless steel, aluminum, tungsten, etc.) and is impermeable to gas and charged particle flow. Cathode 200 encompasses a plurality of isolated electrically conductive rod or wire disposed in a way as not to touch the inner surface of cathode 200. There are eighteen identical electrically conductive rods in this embodiment numerated 310a-310r. FIG. 3A shows a front view of electrically conductive rod 310a. Between both linear sections of electrically conductive rod 310a, lies an arc resembling that of a half circle. Electrically conductive rods 310a-310r all are configured in a way as to resemble a generally spherical accelerator cage 300 as shown in FIG. 3B. Accelerator cage 300 in turn concentrically encompasses a generally spherical anode 400 having a threaded nut 402 at its base shown in FIG. 4. Anode 400 and accelerator cage 300 both are comprised of an electrically conductive material as like cathode 200 and do not make tactile contact. In contrast to cathode 200, accelerator cage 300 and anode 400 both have a high degree of permeability to gas and charged particle flow upwards of ninety five percent.

Referring back to FIG. 2, suitable electrical connections are made to cathode 200 and anode 400 from a power supply 600. A lead 610 is attached to anode 400 for application of a positive potential from power supply 600, while another lead 620 is attached to cathode 200 from the negative terminal of power supply 600. A separate power supply 700 is employed for applying a different electrical potential to accelerator cage 300 than cathode 200. Other suitable electrical connections are made from power supply 700 to accelerator cage 300 via an electrical switching apparatus 500. FIG. 5 shows a front view of electrical switching apparatus 500. Again referring back to FIG. 2, a lead 710 is attached from the negative terminal of power supply 700 to electrical switching apparatus 500. The electrical potential generated by power supply 700 is transferred symmetrically, and relatively simultaneously, by electrical switching apparatus 500 to a plurality of electrically conductive rod 310a-310r that comprise accelerator cage 300. This plural transfer of the electrical potential generated by power supply 700 is represented by connection 720. Another lead 730 is attached from accelerator cage 300 to one end of a resister 800 with the other end of resister 800 going to ground. Yet another lead 740 is attached from the positive terminal of power supply 700 to ground. In this embodiment cathode 200, accelerator cage 300, power supply 600, and power supply 700 all are grounded.

### Electrical Switching Apparatus—FIG. 6, FIG. 7A-7C, FIG. 8A-8E, FIG. 9A-9H, FIG. 10A-10E, FIG. 11, FIG. 12

Beginning with FIG. 6, an exploded view of electrical switching apparatus 500 is shown where a servo motor 30 having a shaft 32 with a male tang, is set into an adaptor 34 that is comprised of a rigid material (e.g. plastic, G10, metal, etc.). A bearing 36 is provided for shaft 32 of servo motor 30 to penetrate. Bearing 36 is set or pressed into a sunken area 38 centrally located within the top face of a top base plate 40 as to be flush with the top face of top base plate 40. FIG. 7A shows a top view of top base plate 40. Top base plate 40 is comprised of a rigid material that has a high degree of resistance to electrical potential (e.g. fiberglass, G10, ceramic, etc.). Servo motor 30 and adapter 34 are both secured to the top of top base plate 40 by a set of four threaded bolts 42 (FIG. 6) comprised of a suitably rigid material (e.g. a metallic material, a plastic material, a ceramic material, etc.). Threaded bolts 42 pass through two aligned sets of four cavities, not numerated, located on servo motor 30 and adapter 34 respectively. Threaded bots 42 are then threaded into a set of four threaded cavities 44 shown in FIG. 7A, that also align with the cavities of servo motor 30 and adapter 34. Threaded holes 44 are located outside of sunken area 38. Compression applied via threaded bolts 42, hold servo motor 30, adapter 34, and bearing 36 secure and in place.

FIG. 7B shows a bottom view of a top base plate with a set of four threaded holes 54. Now moving on to FIG. 7C, a top view of a power transfer plate or ring 46 is shown. Power transfer ring 46 is comprised of an electrically conductive material (e.g. copper, brass, gold etc.) and has a set of four tapered cavities 48, located within its bottom face as shown in FIG. 7D. Tapered cavities 48 align with threaded holes 54. Referring to FIG. 7E, the bottom face of top base plate 40 and the top face of power transfer ring 46 are arranged to face each other. A set of threaded and tapered screws denoted by numerals 50, 51, and 52, penetrate three of the four tapered cavities of 48. Another threaded and tapered screw 53 penetrates the remaining tapered cavity of 48. Threaded and tapered screws 50, 51, 52 and 53 are all comprised of an electrically conductive material as like power transfer ring 46. In contrast to tapered and threaded screws 50, 51, and 52; tapered and threaded screw 53 is longer. Threaded and tapered screws 50, 51, 52, and 53, then thread into threaded holes 54. When assembled, the heads of threaded and tapered screws 50, 51, 52, and 53, are flush with the bottom face of power transfer ring 46. Threaded and tapered screw 53 protrudes past the top face of top base plate 40 while threaded and tapered screws 50, 51, and 52 do not. Again, compression applied via threaded and tapered screws 50, 51, 52, and 53 secure power transfer ring 46 to the bottom of top base plate 40. Of important note, lead 710 attaches to threaded and tapered screw 53.

Referring now to FIG. 8A, a front view of a plate or disk 56 is shown. Disk 56 is comprised of an electrically insulating material as like top base plate 40. Disk 56 has a circularly rising tapered surface that culmnates at its center. Both the top and bottom faces of disk 56 are symmetrical. FIG. 8B shows an isometric view of disk 56. A plurality of cavity, there are two in this embodiment, numerated 58 and 59, are symmetrically located near the edges of disk 56. A cavity 60, having a shape as to accept a shaft 62 with a key 64 is located in the center of disk 56. FIG. 8C shows an isometric view of shaft 62, key 64, and a set of keepers numerated 65 and 66 along with part of shaft 32. Shaft 62 is comprised of a rigid material as like threaded bolts 42, is of one piece, and has a plurality of differing diameter. Keepers 65 and 66 are comprised of a semi-rigid material (e.g. spring steel, plastic, etc.). A female tang 68, located in the top section of shaft 62, is provided for the mating of shaft 32 with shaft 62. The diameter of the top section of shaft 62 is such as to penetrate bearing 36. A lip 70, being of a greater diameter and also being located below female tang 68, is provided for a face of the inner race of bearing 36 to rest on.

Briefly referring back to FIG. 7B, the bottom view of top base plate 40 shows a cavity 71 located geometrically opposite of sunken area 38. The radius of cavity 71 is less than that of sunken area 38. Now continuing with FIG. 8C, the diameter of lip 70 is also as such as to fit within the radius of cavity 71. The middle section of shaft 62, containing its greatest diameter, has a set of two grooves numbered 72 and 73 for the reception of keepers 65 and 66. The middle section of shaft 62 also contains a keyway 74. Another lip 76 is located below the middle section of shaft 62. As like lip 70, lip 76 is of a diameter as to rest upon a face of the inner race of a bearing 92 shown in FIG. 6. The bottom section of shaft 62 has a diameter as to penetrate bearing 92.

Moving on to FIG. 8D, a closer view of a plate or disk assembly is shown. A plurality of stud numerated 78 and 79, relative to cavity 58 and cavity 59, are also shown. Stud 78 and stud 79 are comprised of an electrically conductive material as like power transfer ring 46 and are also identical to each other. Each end of stud 78 and each end stud 79 are threaded while their middle sections are not. FIG. 8E shows a more detailed view of stud 79. Continuing with FIG. 8D, stud 78 and stud 79 are both pressed into cavity 58 and cavity 59 respectively. A plurality of conductor, numerated 80, 81, 82, and 83, having threaded recesses, are threaded onto each of the ends of studs 78 and 79. In this embodiment conductors 80, 81, 82, and 83 all have a generally spherical shape and all are also comprised of an electrically conductive material as like power transfer ring 46. Briefly referring back to FIG. 8C, key 64 is inserted into keyway 74. Now continuing with FIG. 8D, key 64 and shaft 62 are then aligned and inserted into cavity 60 until grooves 72 and 73 (FIG. 8C) are both exposed above the culminated areas of disk 56. Keepers 65 and 66 are then inserted into grooves 72 and 73 securing shaft 62 to disk 56.

Referring now to FIG. 9A, a top view of a stud plate 84 is shown. Stud plate 84 is comprised of an electrically insulating material as like top base plate 40. A sunken area 93 is centrally located within the top face of stud plate 84. A plurality of cavity is located near the edge of stud plate 84. There are eighteen cavities in this embodiment numerated 86a-86r. Moving on to FIG. 9B, an isometric view of a plurality of identical conductor or stud is shown numerated 87a-87r. Studs 87a-87r all are comprised of an electrically conductive material as like power transfer ring 46 and all are also relative to cavities 86a-86r. Studs 87a-87r all are identical to each other. Centrally located within the bottom face of each of studs 87a-87r is a recess 85 as shown in FIG. 9C. Now moving on to FIG. 9D, the top face of stud plate 84 and the bottom faces of all studs 87a-87r are arranged to face each other. FIG. 9D also shows bearing 92. Studs 87a-87r all are pressed into cavities 86a-86r as to leave a significant upper portion of every stud 87a-87r exposed above the top face of stud plate 84. Bearing 92 is then set or pressed into sunken area 93 as for a face of bearing 92 to be flush with the top face of stud plate 84.

Moving on to FIG. 9E, a bottom view of stud plate 84 is shown. Within the bottom face of stud plate 84 is a plurality of channel or groove, numerated 88a-88r, that are all relative to cavities 86a-86r. Grooves 88a-88r all begin within a face of every cavity 86a-86r and terminate near the center of stud plate 84. Grooves 88a-88r all are of a suitable depth, length, and shape as to accept a plurality of electrical conductor or wire. FIG. 9F shows an isometric view of a plurality of electrical conductor or wire numerated 89a-89r. Wires 89a-89r all are comprised of an electrically conductive material as like power transfer ring 46 and all are identical to each other. FIG. 9G shows a left side view of wire 89a having bent end portions numerated 90 and 91. Now moving on to FIG. 9H, wires 89a-89r all are shown to be aligned with grooves 88a-88r. End portion 91 is aligned with recess 85 of stud 87a. All end portions identical to end portion 91 of wires 89b-89r are aligned with recesses identical to recess 85 in every stud 87b-87r. End portion 91 of wire 89a is then inserted into recess 85 of stud 87a while the middle section of wire 89a is set into groove 88a as to be flush with the bottom face of stud plate 84. End portion 90 of wire 89a is raised in relation to the bottom face of stud plate 84. Wires 89b-89r all are then inserted into recesses identical to recess 85 in every stud 87b-87r, while also being set into each groove 88b-88r as like wire 89a. All end portions identical to end portion 90 of wires 89b-89r are also raised in relation to the bottom face of stud plate 84.

On to FIG. 10A; FIG. 10A shows an isometric bottom view of a bottom base plate 94 with a sunken area 97 centrally located within its bottom face. Bottom base plate 94 is comprised of an electrically insulating material as like top base plate 40. FIG. 10B shows a detailed bottom view of sunken area 97. Located within, and near the boundary of sunken area 97, is a plurality of cavity numerated 95a-95r. Another plurality of cavity numerated 96a-96f is also shown to be located outside the boundary of sunken area 97. Cavities 95a-95r all are of a suitable size as to accept a plurality of electrical connector numerated 98a-98r shown in FIG. 10C. Electrical connectors 98a-98r all are comprised of an electrically conductive material as like power transfer ring 46 and all are also identical to each other. Each electrical connector 98a-98r all are of a suitable size and shape as to accommodate end portion 90 of wire 89a. Electrical connectors 98a-98r all are then inserted or pressed into cavities 95a-95r, as shown in FIG. 10D, until their top ends are flush with the top face of bottom plate 94. Every bottom end of every electrical connector 98a-98r sets flush with the lowest point of sunken area 97.

Referring now to FIG. 10E, a detailed top view of the center of bottom base plate 94 is shown to have a plurality of sunken area numerated 99a-99f. Sunken areas 99a-99f all are geometrically located opposite of cavities 96a-96f. Sunken areas 99a-99f all have a suitable shape as to accept a plurality of threaded bolt numerated 100a-100f shown in FIG. 11. Threaded bolts 100a-100f all are comprised of a rigid material as like threaded bolts 42 and are all identical to each other. Sunken areas 99a-99f all are also of a sufficient depth as to accept a plurality of covering or cap numerated 102a-102f. Caps 102a-102f all are comprised of an electrically insulating material as like top base plate 40 and all are also of a shape as to fit into sunken areas 99a-99f. Caps 102a-102f all are identical to each other. Threaded bolt 100a is aligned and inserted into sunken area 99a until its head reaches the bottom of sunken area 99a. Threaded bolts 100b-100f all are then aligned and inserted into sunken areas 99b-99f as like threaded bolt 100a. The shape of sunken areas 99a-99f negates any lateral and rotational movement of threaded bolts 100a-100f. The threaded sections of threaded bolts 100a-100f all protrude past the bottom face of bottom base plate 94. Cap 102a is then aligned with and pressed into sunken area 99a until its bottom face reaches the top of threaded bolt 100a. Caps 102b-102f all are then aligned and pressed into sunken areas 99b-99f as like cap 102a. Caps 102a-102f all negate any vertical movement of every threaded bolt 100a-100f thus securing them. The top faces of every cap 102a-102f all sit flush with the top face of bottom base plate 94.

Continuing with FIG. 11, the bottom face of stud plate 84 and the top face of bottom base plate 94 are shown to be facing each other. Stud plate 84 and bottom base plate 94 each have a set of three cavities that align with each other. These cavities are numerated 103a-103c on stud plate 84 and 104a-104c on bottom base plate 94. A set of three pegs or dowels numerated 105a-105c are also shown to be aligned with both sets of cavities 103a-103c and 104a-104c. Dowels 105a-105c all are comprised of an electrically insulating material as like top base plate 40. End portion 90 of wire 89a is aligned with connector 98a (not shown). All end portions identical to end portion 90 of wires 89b-89r, all are also aligned with their corresponding connector 98b-98r as like wire 89a. Every wire 89a-89r is then inserted into its corresponding connector 98a-98r until the bottom face of stud plate 84 is touching the top face of bottom base plate 94. Dowel 105a is then pressed into cavity 103a on stud plate 84 as well as into aligned cavity 104a on bottom base plate 94. Dowels 105b and 105c both are also pressed into their correspondingly aligned cavities 103b and 104b as well as 103c and 104c as like dowel 105a. Dowels 105a-105c all secure stud plate 84 to bottom base plate 94.

Moving on to FIG. 12, illustrated is a final assembly of electrical switching apparatus 500. As shown, the top face of top base plate 40 is opposite the bottom face of disk 56. In turn, the top face of disk 56 is opposite the bottom face of bottom base plate 94. The bottom section of shaft 62, of disk 56, is aligned with bearing 92. Furthermore female tang 68 of shaft 62 is aligned with the male tang of shaft 32 (not shown). Bottom base plate 94 contains a plurality of cavity numerated 110a-110d shown to be aligned with another plurality of cavity 106a-106d located near the edges of top base plate 40. In between cavities 106a-106d and cavities 110a-110d, is a plurality of peg or dowel numerated 108a-108d. Dowels 108a-108d all are comprised of an electrically insulating material as like top base plate 40 and all are also aligned with cavities 110a-110d.

Beginning with shaft 62 of disk 56, the bottom section of shaft 62 is set or pressed into bearing 92 until lip 76 of shaft 62 rests upon the inner race of bearing 92. Dowel 108a is then pressed into cavity 110a until its bottom face is flush with the bottom face of bottom base plate 94. Following dowel 108a, dowels 108b-108d all are pressed into their corresponding cavities 110b-110d. Substantial upper portions of all dowels 108a-108d set raised above the top face of bottom base plate 94. The male tang of shaft 32 is then mated to female tang 68 of shaft 62 while the upper portions of studs 108a-108d all are pressed into aligned cavities 106a-106d of top base plate 40. The inner race of bearing 36 rests on lip 70 of shaft 62. The top faces of every dowel 108a-108d all set flush with the top face of top base plate 40.

Referring back to FIG. 5, a spatial gap exists between the bottom face of power transfer ring 46 and electrical conductor 80. There is also another spatial gap between the bottom face of power transfer ring 46 and electrical conductor 82. Additional spatial gaps exist between every top face of every stud 87a-87r and electrical conductor 81, as well as electrical conductor 83. All previously mentioned spatial gaps allow for unimpeded rotation of disk 56. A separate small power supply is attached to servo motor 30 to enable said rotation of disk 56.

### Cathode, Accelerator Cage, and Anode—FIG. 13, FIG. 14A-14C, FIG. 15, FIG. 16A-16B, FIG. 17, FIG. 18, FIG. 19A-19C, FIG. 20, FIG. 21, FIG. 22

Starting with FIG. 13, an exploded view of cathode 200 and accelerator cage 300 is shown along with anode 400. Comprising cathode 200 is a pair of hemispheres numerated 201 and 202. At the culmination point of hemisphere 201 is a conduit 204 having a flange 206 at its end. Conduit 204 protrudes above the outer surface of hemisphere 201. Conduit 204 and flange 206 are both comprised of an electrically conductive material as like cathode 200. Flange 206 is provided for the hermetic attachment of an insulator 208 having another flange 210. Insulator 208 is comprised of an electrically insulating material as like top base pate 40 while flange 210 is comprised of an electrically conductive material as like cathode 200. Jutting from the top, and running through the center of insulator 208, is an electrical conductor 212. Electrical conductor 212 is comprised of an electrically conductive material as like power transfer ring 46 and is electrically isolated from flange 210 by insulator 208. The top part of electrical conductor 212 is exposed for the attachment of lead 610 while its bottom part is flush with the bottom face of insulator 208.

Moving on to FIG. 14A, a bottom view of insulator 208 is shown. Within flange 210 and located near its outer edge are a plurality of cavity, there are six in this embodiment, numerated 213a-213f. There is also a contrarily tapered sunken area 214 beginning near cavities 213a-213f of flange 210 and culminating at or near its inner edge. Cavities 213a-213f and contrarily tapered sunken area 214 are separated and do not touch one another. The bottom of insulator 208 is flush with the bottom face of flange 210. Centrally located within the bottom face of insulator 208 as well as within electrical conductor 212 is a threaded recess 216.

Referring now to FIG. 14B, a front view of flange 206 is shown. Located within flange 206 and also near its outer edge, is a plurality of cavity numerated 217a-217f relative to cavities 213a-213f of flange 210. As like flange 210, a contrarily tapered sunken area 218 begins near cavities 217a-217f of flange 206 and culminates at or near its inner edge. Again as like flange 210, cavities 217a-217f and contrarily tapered sunken area 218 are separated and do not touch one another. Divergent to flange 210 however, is a plurality of channel or groove, there are two in this embodiment, numerated 220 and 221 within the front face of flange 206. Groove 220 is located between cavity 217e and cavity 217f, while groove 221 is located between cavity 217b and cavity 217c. Groove 220 and groove 221 are both of the same depth as the lowest point of contrarily tapered sunken area 218. Groove 220 and groove 221 also both run from the beginning of contrarily tapered sunken area 218 and terminate within the outer edge of flange 206.

Now moving to FIG. 14C, the bottom face of insulator 208 is shown to be arranged as to oppose the front face of flange 206 with a seal or gasket 222 in between. Gasket 222 is comprised of a deformable material (e.g. copper, rubber, silicone, etc.) and is also of a shape as to fit contrarily tapered sunken area 214 as well as contrarily tapered sunken area 218. A plurality of threaded bolt numerated 223a-223f, as well as a plurality of threaded nut numerated 224a-224f, is also shown. Threaded bolts 223a-223f and threaded nuts 224a-224f all are comprised of a suitably rigid material as like threaded bolts 42.

Continuing with FIG. 14C, gasket 222 is set into contrarily tapered sunken area 218. Cavity 213f is then aligned with cavity 217f. Contrarily tapered sunken area 214 of flange 210 is also aligned with gasket 222. Flange 210 now is set onto flange 206 with gasket 222 protruding into contrarily tapered sunken area 214. Threaded bolt 223f then penetrates cavity 213f and cavity 217f until its head rests upon the top face of flange 210. The bottom of threaded bolt 223f protrudes past the back face of flange 206. Threaded nut 224f is then threaded onto the exposed end of threaded bolt 223f until one of its faces reaches the back face of flange 206. Threaded bolts 223a-223e each then penetrate every cavity 213a-213e and also every cavity 217a-217e as like threaded bolt 224f. Threaded nuts 224a-224e all are then threaded onto their respective threaded bolts 223a-223e as like threaded nut 224f. Compression applied to flange 210 and flange 206 via threaded bolts 223a-223f and threaded nuts 224a-224f, force gasket 222 to form to contrarily tapered sunken area 214 and contrarily tapered sunken area 218. Excess deformation of gasket 222 spills into groove 220 and groove 221. The compression of gasket 222 creates a hermetic seal between conduit 204 and insulator 208. All hermetic attachments in this embodiment are made in this manner.

Referring back to FIG. 13, located below conduit 204 is a conduit 226 having a flange 228. As like conduit 204, conduit 226 protrudes above the outer surface of hemisphere 201. Conduit 226 is identical to conduit 204 in every respect, exclusionary of size, as conduit 226 is scaled down. Flange 228 is provided for the hermetic attachment of an insulator 230 having a flange 232. Flange 232 is identical to flange 210 of insulator 212 in every respect, exclusionary of size, as flange 232 is of the same scale as flange 228.

FIG. 15 shows a lateral isometric view of insulator 230. Insulator 230 is comprised of an electrically insulating material as like top base plate 40 and protrudes above both the top and bottom faces of flange 232. Running through the center and jutting at both ends of insulator 230 is an electrical conductor 234. Electrical conductor 234 is comprised of an electrically conductive material as like power transfer ring 46 and is electrically isolated from flange 228 by insulator 230. The top end of electrical conductor 234 is provided for the attachment of lead 730. Within its lateral face and near the bottom end of electrical conductor 234 lies a channel or groove 236 provided for the attachment of an electrical connector 256. Electrical connector 256 is comprised of an electrically conductive material as like power transfer ring 46, and is attached to an electrically conductive wire 258, having another electrical connector 260, at its opposite end. Wire 258 and electrical connector 260 are both comprised of the same material as electrical connector 256. Electrical connector 256 has a protrusion that juts above its inner surface (not shown) for mating with groove 236.Connector 256 is then attached to the bottom part of electrical conductor 234 at groove 236. Again referring back to FIG. 13, a gasket 238 is provided for hermetic sealing between insulator 230 and conduit 226. Insulator 230 is then hermetically attached to conduit 226.

Continuing with FIG. 13, a pipe 240 having a flange 242 is shown to be located below conduit 204. Pipe 240 is identical to conduit 204 in every respect and is provided for the hermetic attachment of a vacuum apparatus not shown. Conduit 204, conduit 226, and pipe 240 all reside above a flange 244 being part of hemisphere 201. Flange 244 is identical in every respect to flange 232 save for differences in its plurality of cavity and scale. Flange 244 possesses a greater plurality of cavity, not numerated, and is also of a greater scale than flange 210. Another flange 246, being part of hemisphere 202, is identical to flange 206 save for differences in its plurality of cavity and scale. Flange 246 possesses a plurality of cavity, also not numerated, corresponding to the plurality of cavity of flange 244. Flange 246 is also of the same scale as flange 244. A gasket 247 is provided for the hermetic sealing of hemisphere 201 and hemisphere 202. Gasket 247 is identical to gasket 222 in every respect only differing in scale. Gasket 247 is of the same scale as flange 244 and flange 246. Between flange 246 and the culmination point of hemisphere 202 is a pipe 248 having a flange 250. Pipe 248 is identical to conduit 226 in every respect. Pipe 248 is provided for the hermetic attachment of a gas supply not shown. At the culmination point of hemisphere 202 is a conduit 252 having a flange 254. Conduit 252 is identical to conduit 204.

Between hemisphere 201 and hemisphere 202 is an insulator 320. Insulator 320 is comprised of an electrically insulating material as like top base plate 40 and is of a shape and size as to fill the inside of conduit 252. FIG. 16A shows a top isometric view of insulator 320.

Located near the outer edge of insulator 320 is a plurality of cavity numerated 322a-322r all relative to electrically conductive rods 310a-310r. Cavities 322a-322r all are of a sufficient size and shape as to accept the top linear section of each electrically conductive rod 310a-310r. Cavities 322a-322r all run from within the top face of insulator 320 into a plurality of groove numerated 324a-324r located within its bottom face. FIG. 16B shows a bottom view of insulator 320. Grooves 324a-324r all begin within a face of every cavity 322a-322r and all terminate within the lateral face of insulator 320. Grooves 324a-324r all are also of a sufficient depth as to allow a portion of the arced section of each electrically conductive rod 310a-310r to rest below the bottom face of insulator 320. Also found within the bottom face of insulator 320 is a plurality of threaded recess, there are two in this embodiment, numerated 326 and 328. Threaded recess 326 is located near groove 324e and groove 324f while threaded recess 328 is located near groove 324n and grove 324o.

Referring to FIG. 17, a bottom isometric view of a cap or covering 330 is shown. Covering 330 is comprised of an electrically insulating material as like top base plate 40 and is of the same shape as insulator 320. Within the bottom face of covering 330 is a plurality of tapered cavity numerated 332 and 334 that are relative to threaded recess 326 and threaded recess 328 of insulator 320. The top face of covering 330 is flush.

Moving on to FIG. 18, a relationship is illustrated between insulator 320, electrically conductive rod 310a, covering 330, and anode 400. As shown, the top linear section of electrically conductive rod 310a is aligned with cavity 322a. The arced section of electrically conductive rod 310a is also shown to be aligned with groove 324a. Opposing the bottom face of insulator 320 is the top face of covering 330. Furthermore, tapered cavity 332 and tapered cavity 334 are shown to be respectively aligned with threaded recess 326 and threaded recess 328. The top linear section of electrically conductive rod 310a is then inserted into cavity 322a until its arced section reaches the lowest point of groove 324a. The bottom face of insulator 320 remains flush, however part of the top linear section of electrically conductive rod 310a, protrudes above the top face of insulator 320. Anode 400 is then temporally attached to the arced section of electrically conductive rod 310a by a temporary fastener 340. Several mechanisms may be employed as temporary fastener 340 (i.e. a wire, a “zip tie”, a piece of “tape”, etc.) however, a piece of tape is used in this embodiment. The top linear section of every electrically conductive rod 310b-310r all are then inserted into their corresponding cavities 322b-322r as like electrically conductive rod 310a. Electrically conductive rods 310a-310r collectively encompass anode 400.

Covering 330 is now placed on the bottom of insulator 320. A pair of threaded and tapered screws numerated 336 and 338 are provided for the attachment of covering 330 to the bottom of insulator 320. Threaded and tapered screw 336 and threaded and tapered screw 338 are both comprised of an electrically insulating material as like top base plate 40. The threaded end of threaded and tapered screw 336 then penetrates tapered cavity 332 while threading into threaded recess 326. The threaded end of threaded and tapered screw 338 then penetrates tapered cavity 334 while threading into threaded recess 328. The head of threaded and tapered screw 336 as well as the head of threaded and tapered screw 338 both set flush with the bottom face of covering 330. Vertical compression applied via threaded and tapered screw 336 and also threaded and tapered screw 338, secures covering 330 to the bottom of insulator 320. The same vertical compression applied via threaded and tapered screw 336 and also threaded and tapered screw 338 in conjunction with grooves 324a-324r, also immobilize electrically conductive rods 310a-310r.

Briefly referring back to FIG. 13, below electrically conductive rods 310a-310r shown is an electrically conductive ring 342 comprised of an electrically conductive material as like power transfer ring 46. FIG. 19A shows a bottom view of electrically conductive ring 342. Between the inner and outer lateral faces of electrically conductive ring 342, is a plurality of cavity numerated 341a-341r relative to electrically conductive rods 310a-310r. Cavities 341a-341r all are of a sufficient size and shape as to accept the bottom linear section of each electrically conductive rod 310a-310r. Also between the inner and outer lateral faces of electrically conductive ring 342 is a plurality of chamfered cavity; there are two in this embodiment numerated 344 and 346. Chamfered cavity 344 lies between cavity 341e and cavity 341f while chamfered cavity 346 lies between cavity 341n and cavity 341o. Cavities 341a-341r all run from within the bottom face of electrically conductive ring 342, into a plurality of groove numerated 343a-343r within its top face. FIG. 19B shows a top view of electrically conductive ring 342. Grooves 343a-343r all begin within a face of every cavity 341a-341r and all terminate within the outer face of electrically conductive ring 342. Grooves 343a-343r all are also of a sufficient depth as to allow a portion of the arced section of each electrically conductive rod 310a-310r to rest below the top face of electrically conductive ring 342. Briefly referring to FIG. 19C, a top isometric view of electrically conductive ring 342 is shown having a threaded recess 348 within its outer lateral face.

Moving on to FIG. 20, a top isometric view of an insulator 350 is shown having a raised area 351. Raised area 351 is centrally located at the top of insulator 350, and is of a size and shape, as to fill the encompassed volume of electrically conductive ring 342. The bottom of insulator 350 is flush. Insulator 350 is comprised of an electrically insulating material as like top base plate 40 and has a size and shape as to fill conduit 204. Centrally located within the top face of raised area 351 and linearly terminating within the bottom face of insulator 350, is a cavity 352. Below raised area 351 and within the top face of insulator 350, lie a pair of threaded recesses numerated 354 and 356 that are relative to chamfered cavity 344 and chamfered cavity 346. Threaded recess 354 and threaded recess 356 also both lie between the lateral face of raised area 351 and the lateral face of insulator 350. Referring now to FIG. 21, a top isometric view of a cap or covering 358 is shown. Covering 358 is comprised of an electrically insulating material as like top base plate 40, and has a cavity 360 located within its top face. Cavity 360 is relative to cavity 352. Near the edge of covering 358 and also within its top face are a pair of tapered cavities numerated 362 and 364. Tapered cavity 362 and tapered cavity 364 are both relative to chamfered cavity 344 and chamfered cavity 346. Covering 358 is of the same shape as insulator 350 divergent of raised area 352.

FIG. 22 illustrates a relationship between electrically conductive ring 342, insulator 350, covering 358, and electrically conductive rods 310a-310r. The bottom face of electrically conductive ring 342 is shown to oppose the top face of insulator 350. The bottom face of covering 358 is shown to oppose the top face of electrically conductive ring 342. Tapered cavity 364, chamfered cavity 346, and threaded recess 356 are all shown to be respectively aligned with each other. Also shown to be respectively aligned, is tapered cavity 362, chamfered cavity 344, and threaded recess 354. Furthermore, cavity 360 is shown to be aligned with cavity 352. Between covering 358 and electrically conductive ring 342, the bottom linear section of each electrically conductive rod 310a-310r all are aligned with cavities 341a-341r (not depicted). Also not depicted, is an alignment between the arced sections of each electrically conductive rod 310a-310r with grooves 343a-343r.

Electrically conductive ring 346 is now set onto the top of insulator 350 with raised area 351 penetrating its encompassed volume. The top face of electrically conductive ring 342 sets flush with the top face of raised area 351. The outer lateral face of electrically conductive ring 342 is flush with the lateral face of insulator 350. Each bottom linear section of every electrically conductive rod 310a-310r all are then inserted into their respective cavities 341a-341r. The arced section of each electrically conductive rod 310a-310r all are then correspondingly inserted into their respective grooves 343a-343r. The top face of electrically conductive ring 342 remains flush. Covering 358 is now set on top of electrically conductive ring 342. A pair of threaded and tapered screws numerated 366 and 368, collectively relative to tapered cavity 362 and tapered cavity 364, are provided for the securing of electrically conductive ring 342 and covering 358 to insulator 350. Threaded and tapered screw 366 and threaded and tapered screw 368 are both comprised of an electrically insulating material as like top base plate 40.

Again referring back to FIG. 13, another electrical conductor 370 is shown between hemisphere 201 and insulator 350. Electrical conductor 370, possessing a threaded section at each end, is comprised of an electrically conductive material as like power transfer ring 46. Electrical conductor 370 is of a shape and size as to penetrate cavity 352, while also retaining a demeanor for threading into threaded recess 216 as well as threaded nut 402.

Continuing with FIG. 13, electrical conductor 370 is shown to be aligned with cavity 352. Also shown is an alignment between insulator 350 and conduit 204, as well as an alignment between insulator 320 and conduit 252. One threaded end of electrical conductor 370 is now threaded into threaded recess 216. Insulator 350 is then inserted into conduit 204 until its bottom face rests against the bottom face of insulator 208. The other threaded end of electrical conductor 370 penetrates cavity 352 and cavity 360. A significant portion of electrical conductor 370 protrudes above the top face of covering 358. Temporary fastener 340 is now removed and discarded. Threaded nut 402 is then threaded onto the other threaded end of electrical conductor 370 providing for a concentric placement of anode 400 within accelerator cage 300. A threaded bolt 262, comprised of an electrically conductive material as like power transfer ring 46, is provided for the attachment of wire 258 to electrically conductive ring 342. Threaded bolt 262 then penetrates connector 260 while threading into threaded recess 348. Vertical compression applied via threaded bolt 262 secures connector 260 to electrically conductive ring 342. Flange 244, gasket 247, and flange 246 are now brought together and hermetically sealed with insulator 320 penetrating conduit 252. The top face of insulator 320 sets flush with the top face of flange 254.

Final assembly—FIG. 23, FIG. 24, FIG. 25, FIG. 26, FIG. 27A-27B, FIG. 28A-28C, FIG. 29

Beginning with FIG. 23, a top isometric view of an insulator 404 is shown. Insulator 404 is comprised of an electrically insulating material as like top base plate 40 and contains a plurality of cavity numerated 406a-406r. Cavities 406a-406r all run from within the top face of insulator 404 and terminate within its bottom face. Cavities 406a-406r all are also relative to electrically conductive rods 310a-310r. Referring now to FIG. 24, an isometric view is shown depicting a plurality of electrical connector numerated 408a-408r. Electrical connectors 408a-408r all are comprised of an electrically conductive material as like power transfer ring 46 and all are also of a shape and size as to penetrate every cavity 406a-406r. In this embodiment each electrical connector 408a-408r is hollow. Moving on to FIG. 25, a top isometric view of a vacuum extension 410 is shown having two flanges numerated 412 and 414. Vacuum extension 410 is comprised of an electrically conductive material as like cathode 200, and is also of a shape and size as to accept insulator 404. Flange 414 is identical to flange 210 while flange 412 is identical to flange 206. Although flange 412 is identical to flange 206, it is necessary to numerate its cavities 416a-416f for the sake of continuity, as will later become clear.

Continuing on to FIG. 26, a relationship is illustrated between electrical connector 408a, insulator 404, and vacuum extension 410. As shown, electrical connector 408a is aligned with cavity 406a while insulator 404 is aligned with the encompassed volume of vacuum extension 410. Electrical connector 408a is now inserted or pressed into cavity 406a until both of its ends become flush with the top and bottom faces of insulator 404. Each remaining electrical connector 408b-408r is then inserted or pressed into corresponding cavities 406b-406r as like electrical connector 408a. Insulator 404 now displaces the encompassed volume of vacuum extension 410. Both the top and bottom faces of insulator 404 set flush with the mating faces of flange 412 and flange 414 respectively.

Moving to FIG. 27A, a top isometric view of an electrical plug 418 is shown having a flange 420. Electrical plug 418 is comprised of an electrically insulating material as like top base plate 40 while flange 420 is comprised of an electrically conductive material as like cathode 200. Jutting out from both the top and bottom faces of electrical plug 418 is a plurality of identical pin numerated 422a-422r. Pins 422a-422r all are comprised of an electrically conductive material as like power transfer ring 46. Pins 422a-422r all are also suitably configured within electrical plug 418 as to respectively align with each electrical connector 98a-98r as well as with every electrical connector 408a-408r. Furthermore, pins 422a-422r all are of a sufficient length as to mate with each electrical connector 98a-98r as well as with every electrical connector 408a-408r. The top face of plug 418 is raised in relation to the top face of flange 420 and possesses a suitable shape and size as to completely fill the encompassed volume of sunken area 97. Referring now to FIG. 27B, a bottom isometric view of electrical plug 418 is shown. Within flange 420 is a plurality of cavity numerated 424a-424f relative to threaded bolts 100a-100f. Cavities 424a-424f all are located between the lateral face of flange 420 and a contrarily tapered sunken area 426. Contrarily tapered sunken area 426 is identical to contrarily tapered sunken area 218 and also functions in an identical manner. Additionally, flange 420 is of a shape and size as to mate with flange 412.

Moving on to FIG. 28A a relationship is illustrated between electrical switching apparatus 500, electrical plug 418, and vacuum extension 410. As shown, the bottom face of flange 420 opposes the mating face of flange 412, while its top face opposes the bottom face of electrical switching apparatus 500. FIG. 28B shows a detailed view of electrical plug 418 and the bottom of electrical switching apparatus 500. Cavities 424a-424f all are shown to be aligned with threaded bolts 100a-100f. Each pin 422a-422r is also respectively aligned with every electrical connector 98a-98r. The top face of electrical plug 418 is now set into sunken area 97 completely filling its encompassed volume. Threaded bolts 100a-100f penetrate cavities 424a-424f while pins 422a-422r penetrate electrical connectors 98a-98r. Every threaded bolt 100a-100f significantly protrudes past the bottom face of flange 420.

Referring back to FIG. 28A, disposed between flange 412 and flange 420 is a gasket 428. Gasket 428 is identical in every respect to gasket 222, and is shown to be aligned with contrarily tapered sunken area 426. Also shown, is an alignment between threaded bolt 100a and cavity 416a. Remaining cavities 416b-416f all are also respectively aligned with remaining threaded bolts 100b-100f, although not depicted. An alignment between electrical connectors 408a-408r and pins 422a-422r is also not depicted. Briefly referring to FIG. 28C, a plurality of threaded nut 430a-430f is illustrated. Threaded nuts 430a-430f all are comprised of a suitably rigid material as like threaded bolts 42 and all are also of a sufficient size as to thread onto every threaded bolt 100a-100f. Again referring back to FIG. 28A, threaded nut 430a is shown to be aligned with cavity 416a as well as with threaded bolt 100a.

Continuing with FIG. 28A, gasket 428 is now set onto contrarily tapered sunken area 426. Vacuum extension 410 is then set onto electrical plug 418 with threaded bolts 100a-100f penetrating cavities 416a-416f. Pins 422a-422r all penetrate each electrical connector 408a-408r as well. A significant portion of each threaded bolt 100a-100f is exposed above the back face of flange 412. Threaded nuts 430a-430f each are now respectively threaded onto every threaded bolt 100a-100f. Vertical compression applied via threaded nuts 430a-430f to flange 412, gasket 428, and flange 420, hermetically attach vacuum extension 410 to electrical plug 418. This same vertical compression secures vacuum extension 410 and electrical plug 418 to electrical switching apparatus 500.

Moving now to FIG. 29, a relationship is illustrated between conduit 252 and vacuum extension 410. As shown, the mating faces of flange 254 and flange 414 oppose each other with a gasket 432 disposed between them. Gasket 432 is identical to gasket 222. Not depicted is an alignment between each electrical connector 408a-408r and every electrically conductive rod 310a-310r. Flange 252, gasket 432, and flange 414 are now brought together with every electrically conductive rod 310a-310r penetrating each electrical connector 408a-408r. Vacuum extension 410 is then hermetically attached to conduit 252 thus securing electrical switching apparatus 500 to cathode 200 as well as to accelerator cage 300. A vacuum pump, not shown, is now hermetically attached to pipe 240. A control valve connected to a reactant gas supply, also not shown, is then hermetically attached to pipe 248.

### Operation—FIG. 30, FIG. 31A-31C, FIG. 32, FIG. 33A-33C, FIG. 34, FIG. 35, FIG. 36

Beginning with FIG. 30, a diagrammatic illustration of the first embodiment is shown for use in explaining the operation thereof. As depicted, vacuum extension 410, insulator 404, cathode 200, accelerator cage 300, and insulator 208 all are cut-away. Utilizing the vacuum pump hermetically attached to pipe 240, cathode 200 is first evacuated. The order of vacuum that must be developed within cathode 200 is 10⁻⁶ to 10⁻⁷ inches of mercury. This permits good out-gassing and insures that in-leakage is low thus minimizing possible contaminants. It should be understood that although the vacuum pump is required to provide a vacuum of the aforesaid magnitude, pressure inside cathode 200 will be much greater during operation.

Moving on to electrical switching apparatus 500, a sufficient electrical potential is now applied to servo motor 30 from the servo motor power supply initiating a rotation of disk 56. In this embodiment the rotation of disk 56 is clockwise. A negative electrical potential of between 70 V and 80 kV is then applied to power transfer ring 46 from power supply 700 via threaded and tapered screw 53. The desired electrical potential applied to power transfer ring 46 is more than sufficient to transit the spatial gaps that exist between power transfer ring 46, electrical conductor 80, and electrical conductor 82. These transits occur almost simultaneously, allowing for a separated plurality of identical electrical potential. This plurality of electrical potential then travels through stud 78 and stud 79 energizing both electrical conductor 81 and electrical conductor 83.

This part of the following discussion is a “snap-shot” in time as the operation of electrical switching apparatus 500 is not of a static nature. The plurality of electrical potential energizing electrical conductor 81 and electrical conductor 83, then transits the spatial gaps that exist between stud 87j and stud 87a. Again, these transits occur almost simultaneously. Stud 87j then transfers its electrical potential to wire 89j while stud 87a transfers its electrical potential to wire 89a. Electrical connector 98j then picks up the electrical potential of wire 89j and transfers it to pin 422j. Likewise the electrical potential of wire 89a is transferred to pin 422a via electrical connector 98a. Wire 89a, electrical connector 98a, and pin 422a all are not shown in FIG. 30. Also not shown in FIG. 30 are wire 89j, electrical connector 98j, and pin 422j.

Continuing, the identical electrical potentials of pin 422j and pin 422a are both transferred almost simultaneously to electrical connector 408j and electrical connector 408a. Electrically conductive rod 310j then picks up the electrical potential of electrical connector 408j and transfers it to electrically conductive ring 342. Likewise the electrical potential of electrical connector 408a is also transferred to electrically conductive ring 342 via electrically conductive rod 310a. In this embodiment every electrically conductive rod 310a-310r is energized in this manor following the corresponding suffix to each relative electrically conductive component (e.g. stud 87b, to wire 89b, to electrical connector 98b, to pin 422b, to electrically conductive rod 310b). It should also be understood that in this embodiment when one electrically conductive rod is energized, a second electrically conductive rod is also energized; always 180° apart from the other (e.g. electrically conductive rod 310e and electrically conductive rod 310n).

Electrically conductive ring 342 now collects and combines the identical electrical potentials of both electrically conductive rod 310j and electrically conductive rod 310a. Electrically conductive ring 342 then transfers this combined electrical potential through electrical connector 260, electrically conductive wire 258, and electrical connector 256 to electrical conductor 234. Lead 730 then picks up the combined electrical potential and feeds it into resister 800 which then transfers the remaining electrical potential to ground; thus terminating the circuit.

As electrical conductor 81 and electrical conductor 83 pass over each stud 87a-87r due to the rotation of disk 56, two electrically conductive rods 310a-310r are constantly energized and de-energized. The frequency at which this occurs is wholly dependent upon the rpm at which disk 56 is being operated. The purpose of this consecutive energizing and de-energizing of pairs of electrically conductive rods 310a-310r is to create a plurality of non-static electric field between cathode 200 and anode 400. There are two non-static electric fields created in this embodiment at any one time. Furthermore, it is the preferred shape of electrically conductive rods 310a-310r that determines the character of the plurality of non-static electric field being generated. In this embodiment each non-static electric field resembles a half circle. When compounded with the rotation of disk 56, the plurality of non-static electric field allows for a NON-RADIAL electromagnetic influence upon any matter within its proximity. Being that the plurality of non-static electric field resembles a half circle, this electromagnetic influence is generally spherical when also compounded with the rotation of disk 56. These non-static electric fields are employed for the ionization and generally spherical rotation of a suitable reactant gas (e.g. Hydrogen, Deuterium, Tritium, Helium³, etc.).

A small amount of reactant gas is now admitted into cathode 200 by means of a control valve hermetically attached to pipe 248. A pressure of 10⁻⁴ millimeters of mercury within cathode 200 is permitted for operation in this embodiment which is regulated and maintained by the vacuum pump and associated valves. Other pressures may possibly be utilized depending upon preferred design characteristics. As the atoms of the admitted reactant gas come within range of either non-static electric field, their electrons are stripped away due to the intensity of whichever non-static electric field they encounter. This converts these atoms into positive ions. The newly created positive ions are then further influenced by the consecutive movement of the non-static electric fields.

FIG. 31A and FIG. 31B both illustrate a further influence from the plurality of non-static electric field upon a pair of positive ions numerated 450 and 460. FIG. 31A and FIG. 31B both are also two dimensional representations of electrically conductive rods 310a-310r and cathode 200. Electrically conductive rod 310b and electrically conductive rod 310k are both darkened in FIG. 31A to depict applied electrical potentials. Likewise electrically conductive rod 310c and electrically conductive rod 3101 both are also darkened in FIG. 31B to depict applied electrical potentials. All arrows in both FIG. 31A and FIG. 31B represent the motion of positive ion 450 and positive ion 460.

Viewing FIG. 31A in conjunction with FIG. 31B, as electrically conductive rod 310b is de-energized its electric field is terminated along with any influence upon positive ion 450. When electrically conductive rod 310c is energized, its electric field then attracts positive ion 450. This causes positive ion 450 to transit across space toward electrically conductive rod 310c. This same process causes positive ion 460 to transit toward electrically conductive rod 3101 when electrically conductive rod 310k is de-energized. Given the character of electrically conductive rods 310a-310r, how they are disposed, and the consecutive energizing and de-energizing thereof, a generally spherical rotating positive ion flow 465 is created between cathode 200 and anode 400. FIG. 31C shows generally spherical rotating positive ion flow 465 from a two dimensional perspective.

Referring back to FIG. 30, a positive electrical potential of 100 kV or less is applied to anode 400 from power supply 600 via lead 610, electrical conductor 212, and electrical conductor 370. At this operating potential a generally spherical positive electric field is created around anode 400. This generally spherical positive electric field attracts electrons from the entire inner surface of cathode 200 as well as from both non-static electric fields. This happens due to the difference in electrical potentials between anode 400, both non-static electric fields, and cathode 200. A secondary effect of this generally spherical positive electric field is an initial repulsion of generally spherical rotating positive ion flow 465. This initial repulsive force creates a volumetrically denser positive ion flow that still retains its generally spherical nature.

A copious amount of electrons now begin to converge upon and transit the encompassed volume of anode 400 due to its high degree of transparency. FIG. 32 diagrammatically illustrates an example of electron transit through the encompassed volume of anode 400. As shown, two electrons numerated 470, and 474 oscillate through the encompassed volume of anode 400 with their trajectories being represented by arrows. Let it be ideally supposed that electron 470 and electron 474 begin from diametrically opposite points of either the inner surface of cathode 200 or the plurality of non-static electric field. Both electron 470 and electron 474 are then radially accelerated toward the geometric center of anode 400. In the absence of any mutually repelling force, electron 470 and electron 474 would logically collide at this geometric center. However being that both electron 470 and electron 474 have an intrinsically negative charge, as they approach the geometric center of anode 400 their mutual charge causes their respective velocities to progressively decrease until they very nearly touch. At this point the velocity of both electron 470 and electron 474 is zero.

In a practical embodiment however, electron 470 and electron 474 do not approach “head-on”, instead they pass each other at minimum velocity rather than stopping. Upon passing each other, electron 470 and electron 474 are both accelerated by their mutual charge and continue on with little or no change in their initial trajectories. Electron 470 and electron 474 both are then further accelerated by the generally spherical positive electric field causing them to be ejected from the encompassed volume of anode 400. Again continuing with these trajectories, electron 470 and electron 474 gain enough velocity to escape the influence of the generally spherical positive electric field momentarily. As electron 470 and electron 474 approach either cathode 200 or the plurality of non-static electric field, they begin to decelerate and eventually stop due to their likeness in charge. This allows electron 470 and electron 474 to once again be attracted to the generally spherical positive electric field of anode 400 thus beginning another transit. All electrons attracted by anode 400 follow radial trajectories, however not every electron makes a transit through its encompassed volume as anode 400 is not completely transparent. A small percentage of electrons relative to the transparency of anode 400 are lost in collisions with its physical structure.

Now assuming a copious quantity of electrons traversing the encompassed volume of anode 400 as described above, and ignoring for the moment both non-static electric fields, a negative charge is contributed to this spatial area from the traversing electrons with maximum intensity being at the geometric center thereof. Thus a virtual cathode 478 develops in the geometric center of anode 400 which can be made to have essentially the same potential as cathode 200. It should be understood that virtual cathode 478 cannot exist without a positive electrical potential being applied to anode 400. Now continuing with the addition of both non-static electric fields, the negative charge of virtual cathode 478 can be further intensified therefore allowing it to be reduced below normal ground. This further intensification takes place only in two geometric sectors or “slices” of virtual cathode 478 at any given time relative to the position of both non-static electric fields. A deeper explanation of this phenomenon is provided below.

Referring to FIG. 33A and FIG. 33B, a two dimensional representation of electrically conductive rods 310a-310r, cathode 200, and virtual cathode 478 is shown. FIG. 31A and FIG. 31B also show a pair of geometric planes numerated 480 and 482 intersecting virtual cathode 478. Electrically conductive rod 310b and electrically conductive rod 310k both are darkened in FIG. 33A to represent applied electrical potentials. Likewise in FIG. 33B, electrically conductive rod 310c and electrically conductive rod 310l both are also darkened to represent applied electrical potentials. All arrows in FIG. 33A and FIG. 33B represent a direction of change for both plane 480 and plane 482. Although virtual cathode 478 is a three dimensional object, it should be considered in terms of two dimensions when contemplating the effect of both non-static electric fields thereon due to the radial oscillations of every electron.

Viewing FIG. 33A in conjunction with FIG. 33B, when electrically conductive rod 310b and electrically conductive rod 310k both are energized, a specific increase of negative charge occurs in two geometric sectors of virtual cathode 478. These specific increases of negative charge are relative to the electrical potential applied to electrically conductive rod 310b as well as electrically conductive rod 310k. Plane 480 and plane 482 represent the shape and position of these specific increases of negative charge. It should be understood that the existence of both plane 480 and plane 482 is dependent upon and in unity with both non-static electric fields.

As shown, plane 480 and plane 482 do not touch. As successive energizing and de-energizing of electrically conductive rods 310a-310r occurs, there is a change in the spatial position of both plane 480 and plane 482. For example when electrically conductive rod 310b is de-energized and electrically conductive rod 310c is energized, the position of plane 482 changes from electrically conductive rod 310b to electrically conductive rod 310c while still intersecting virtual cathode 478. The position of plane 480 is likewise changed when electrically conductive rod 310k is de-energized and electrically conductive rod 3101 is energized. Referring now to FIG. 33C, a two dimensional side view of plane 480 and plane 482 is shown along with the affected sectors of virtual cathode 478. As depicted an axis 484 runs through the center of virtual cathode 478. Both plane 480 and plane 482 rotate around axis 484. This causes two very large sectors or “slices” of virtual cathode 478 to be intensified at any one time. If perceived in three dimensions, the successive movement of both plane 480 and plane 482 gives into an illusion of virtual cathode 478 being rotated. Virtual cathode 478 does not rotate however; rather specific “slices” thereof are consecutively intensified and then returned to their original negatively charged state.

Now taking into account generally spherical rotating positive ion flow 465, the effect of virtual cathode 478 thereupon is one of attraction. When virtual cathode 478 reaches preferred intensity, the intensity of both non-static electric fields is reduced to a point at which virtual cathode 478 can effectively begin to change the trajectory of every circulating ion. This change in trajectory is of a controlled nature and best explained in terms of a mathematic equation:

$$r = \frac{α}{θ}$$

When applied, α represents the intensity of both non-static electric fields, θ represents the intensity of virtual cathode 478, and r equates to the spatial position of a positive ion. This new trajectory is essentially that of a hyperbolic spiral as shown in FIG. 34. As virtual cathode 478 exerts its influence upon positive ion 450 in conjunction with the influence of a non-static electric field, positive ion 450 can be continually accelerated on a spiraling trajectory toward the center of virtual cathode 478 if so desired. By manipulating the intensity of virtual cathode 478 as well as the intensities of both non-static electric fields, generally spherical rotating positive ion flow 465 can be disposed anywhere between accelerator cage 300 and the geometric center of anode 400. This allows for a generally spherical convergence of said ion flow upon the vicinity of virtual cathode 478 therefore producing an option for creating a rotating sphere or “ball” of plasma thereabout. In this embodiment a rotating sphere of plasma encompasses virtual cathode 478.

Through this method, only positive ions on the leading edge of generally spherical rotating positive ion flow 465 are permitted to reach the center of virtual cathode 478. It should be understood that this method also controls the rate at which nuclear-fusion reactions will occur. Referring to FIG. 35, a two dimensional detailed view of virtual cathode 478 is shown as well as generally spherical rotating positive ion flow 465 in reciprocation of this perception. As shown, positive ion 450 and positive ion 460 spiral toward the center of virtual cathode 478. Eventually both positive ion 450 and positive ion 460 reach a point at which neither plane 480 nor plane 482 have any influence over them. At this point positive ion 450 and positive ion 460 are further accelerated, although now radially, toward the geometric center of virtual cathode 478 as well as toward one another. The velocities achieved in this further acceleration are great enough to induce a nuclear-fusion reaction if a “head-on” collision occurs. If this collision is not “head-on”, neither positive ion 450 nor positive ion 460 is lost. The escape of positive ion 450 and positive ion 460 is obstructed form the vicinity of virtual cathode 478 by their like charge to generally spherical rotating positive ion flow 465. As positive ion 450 and positive ion 460 approach generally spherical rotating positive ion flow 465, their velocities are reduced enough for either plane 480 or plane 482 to influence positive ion 450 and or positive ion 460 once again. This allows for both positive ion 450 and positive ion 460 to be re-circulated within virtual cathode 478 indefinitely until they collide “head-on.”

When a “head-on” collision occurs between positive ion 450 and positive ion 460, the resultant product is a free neutron 486 that is then ejected from the point at which both positive ion 450 and positive ion 460 are fused. It should be understood that the energy of free neutron 486 is relative to the preferred reactant gas utilized. The trajectory of free neutron 486 is unwaveringly radial until generally spherical rotating positive ion flow 465 is reached. This is due to a lack of net electrical charge inherent to free neutron 486. When generally spherical rotating positive ion flow 465 is reached, scattering of free neutron 486 occurs. FIG. 36 shows a simple vector plot clarifying the scattering of free neutron 486. As shown, free neutron 486 is on a vector 490 beginning from the geometric center of virtual cathode 478 having polar coordinates (0, r′). A positive ion 488 within generally spherical rotating positive ion flow 465 is also shown to be on an intersecting vector 492 having polar coordinates (−r, r′). When free neutron 486 and positive ion 488 collide, a new vector 494 is produced resulting in a significant change in trajectory of free neutron 486 as well as a loss in velocity.

Scattering of free neutron 486 generates heat energy that effectively increases temperature within generally spherical rotating positive ion flow 465. This increase of temperature is relative to the initial trajectory of free neutron 486 compounded by every scattering reaction thereof and also facilitates further nuclear-fusion reactions. Eventually free neutron 486 is either reduced in energy to a thermal state, or captured by a positive ion within generally spherical rotating positive ion flow 465. The capture of free neutron 486 is entirely dependent upon two factors; the velocity of free neutron 486 and the density of generally spherical rotating positive ion flow 465. Both of these factors can be manipulated by choice of “fuel” and the addition of preferred reactant gas.

### Second Embodiment—FIG. 37, FIG. 38A-38B

Most parts within this embodiment are identical to the previous embodiment as well as the structures of the anode, cathode, and accelerator cage. Identical parts are therefore distinguished with a letter suffix—x applied at the end of each like numeral.

Beginning with FIG. 37, a second embodiment of an electrical switching apparatus relating to an anode, a cathode, and an accelerator cage is shown. As depicted, hemisphere 201x is partially cut away with electrical switching apparatus 500 being replaced by a solid state electrical switching apparatus 510. Solid state electrical switching apparatus 510 is devoid of any moving parts and is comprised of a plurality of isolated silicon controlled rectifier as well as an electrical switch board 514. There are eighteen isolated silicon controlled rectifiers in this embodiment numerated 512a-512r. The anode lead of each silicon controlled rectifier 512a-512r is connected to an electrical lead 515 within electrical switch board 514. Power to lead 515 is supplied by power supply 700x which is attached via lead 710x. Each cathode lead of every silicon controlled rectifier 512a-512r is isolated, routed, and connected via electrical switch board 514 to an electrical cable 520. Electrical cable 520 is comprised of a plurality of isolated electrically conductive wire (not illustrated) relative to the cathode lead of each silicon controlled rectifier 512a-512r. Electrical cable 520 also has an electrical plug 522 at one of its ends.

Referring to FIG. 38A, a bottom view of electrical plug 522 is shown. As depicted, centrally located within the bottom face of electrical plug 522 is a plurality of female electrical connector numerated 524a-524r. Every female electrical connector 524a-524r is electrically isolated and is also of a shape and size as to accept a portion of the top linear section of every electrically conductive rod 310ax-310rx. Furthermore, the design of electrical plug 522 is so as to allow it to be hermetically attached to electrical conduit ²⁵²x in the same manner as hermetic attachments are made in the previous embodiment. FIG. 38B is a bottom isometric view of electrical plug 522 showing a contrarily tapered sunken area 526 utilized in hermetic attachment.

Referring back FIG. 37, the gate lead of every silicon controlled rectifier 512a-512r is isolated, routed, and connected via electrical switch board 514 to another electrical cable 518. Electrical cable 518 is comprised of a plurality of isolated electrically conductive wire (also not illustrated) relative to the gate lead of each silicon controlled rectifier 512a-512r. Electrical cable 518 is attached to a programmable logic controller (PLC) 516. Programmable logic controller 516 is provided to facilitate an electrical switching of every silicon controlled rectifier 512a-512r. Furthermore programmable logic controller 516 is also connected to a separate power supply to enable the operation thereof.

Moving on to the operation of this embodiment, a standing negative electrical potential of between 70V and 80k V is applied to lead 515. This in turn energizes the anode leads of every silicon controlled rectifier 512a-512r. A plurality of equal electrical potential is now simultaneously applied to a plurality of gate lead from programmable logic controller 516. In this embodiment only two gate leads are energized at any one time. It should be understood that through the utilization of a programmable logic controller in conjunction with a plurality of silicon controlled rectifier a larger multiple of gate lead can be energized at any one point in time; this understanding of course being dependent upon the plurality of silicon controlled rectifier being employed relative to the addressing capability of the programmable logic controller.

As like the previous embodiment, this part of the following discussion is a “snap-shot” in time. Both silicon controlled rectifier 512e and silicon controlled rectifier 512n are darkened to represent applied electrical potentials to their gate leads. Each identical electrical potential applied from programmable logic controller 516 is great enough to “activate” silicon controlled rectifier 512e as well as silicon controlled rectifier 512n. This allows for the electrical potential applied to electrical lead 515 to be transferred to the cathode leads of both silicon controlled rectifier 512e and silicon controlled rectifier 512n. Each isolated electrical potential is then routed and transferred through electrical switch board 514 to electrical cable 520. These isolated electrical potentials are then simultaneously transferred through female electrical connector 524e as well as female electrical connector 524n to electrically conductive rod 310ex and electrically conductive rod 310nx.

There is no further discussion concerning the operation of this embodiment as it would be identical to the operation of the previous embodiment.

### Third Embodiment—FIG. 39

Briefly referring to FIG. 39, an electrically conductive rod 550 is shown relating to a third embodiment. As shown, the geometry of electrically conductive rod 550 does not resemble that of a half circle. Electrically conductive rod 550 should be considered as an alternative design to every electrically conductive rod 310a-310r that comprise accelerator cage 300. If this design were to be implemented, the geometry of both plane 480 and plane 482 would be altered. This would not significantly affect the operation of either of the previously described embodiments adversely or otherwise.

### Fourth Embodiment—FIG. 40

Referring to FIG. 40, an electrically conductive rod 570 having an electrically conductive wire 575 is shown relating to a fourth embodiment. Electrically conductive rod 570 is identical to electrically conductive rod 310a. As shown, electrically conductive wire 575 is wrapped around the arced section of electrically conductive rod 570 creating a coiled structure thereabout. Electrically conductive wire 575 is comprised of an electrically conductive material (e.g. gold, copper, tungsten, etc.) and is insulated. Electrically conductive rod 570 should be considered as another alternative design to every electrically conductive rod 310a-310r that comprise accelerator cage 300.

If this design were to be implemented, the electrical potential applied to electrically conductive rod 570 would also be applied to electrically conductive wire 575. This would generate a magnetic field thereabout. A generally spherical rotating magnetic field would then be created as well as a generally spherical rotating electric field. The effect a generally spherical rotating magnetic field would have upon the operation of either the first or second embodiment is unclear; as is the benefit or disadvantage of the addition of a generally spherical rotating magnetic field.

### Advantages

From the description above, a number of advantages of some of the embodiments of my electrical switching apparatus and generally spherical accelerator cage become apparent:
(a) Causing positive ions to circulate through a generally spherical rotating electric field, and then introducing a virtual cathode, positive ions can be influenced to either spiral or change position between both electric fields, this in turn can give control over the rate at which a nuclear-fusion reaction occurs.
(b) Surrounding a nuclear-fusion reaction with a generally spherical rotating positive ion flow can reduce neutron flux levels to a minimum if not to zero, which in turn can increase the reliability of all apparatuses involved in producing a nuclear-fusion reaction.
(c) The scattering of neutrons within a generally spherical rotating positive ion flow can increase the temperature of said ion flow, which in turn can facilitate further nuclear-fusion reactions.

Although the description above contains much specificity, this should not be construed as the limitation of scope, but rather as the exemplification of several currently preferred embodiments thereof. Many other variations are possible. For example a polyhedral, cylindrical, or other three dimensional geometry could be employed for the cathode as well as the accelerator cage; the electrical switching apparatus could be connected via cables or wires; the electrical switching apparatus could switch applied electrical potentials counterclockwise; paint or pigment could be applied to apparatuses to alter the aesthetics thereof; apparatuses could be scaled up or down, etc.

Accordingly, the scope should be determined not by the embodiments illustrated, but by the appended claims and their legal equivalents.

### REFERENCES

P. T. Farnsworth U.S. Pat. No. 3,258,402 issued Jun. 28, 1966
P. T. Farnsworth U.S. Pat. No. 3,386,883 issued Jun. 4, 1968
Robert L. Hirsch U.S. Pat. No. 3,530,036 issued Sep. 22, 1970
Robert L. Hirsch U.S. Pat. No. 3,533,910 issued Oct. 13, 1970
Robert L. Hirsch U.S. Pat. No. 3,530,497 issued Sep. 22, 1970
Robert W. Bussard U.S. Pat. No. 4,826,626 issued May 2, 1989
Robert W. Bussard U.S. Pat. No. 5,160,695 issued Nov. 3, 1992
“Currents Limited by Space Charge between Concentric Spheres” Irving Langmuir, Katherine B. Blodgett, Physics Review, 23, pp 49-59, 1924
“On the Inertial-Electrostatic Confinement of a Plasma” William C. Elmore, James L. Tuck, and Kenneth M. Watson, The Physics of Fluids, v. 2, no 3, May-June, 1959
“Electrostatic Centripetal Confmement” Nathan Sanders and Frank Sanders, Copy Write Office and Library of Congress, Publishing Pending, Filling Date: Aug. 1, 2008

I claim

1. An apparatus for producing a negative rotating electrical field for the purpose of reduction of neutron flux and or neutron containment and producing a spherical rotating plasma energy comprising:
cathode means, anode means inside said cathode, electrical switching apparatus means, a device which delivers a plurality of electrical energy to an accelerator cage, accelerator cage means, spaced from and disposed between the anode and the cathode, anode means defining a volume centrally located with respect to all of said cathode, accelerator cage and anode means, volume being free of tangible structure, a means for applying a potential to said accelerator cage, said accelerator cage means for establishing a negative rotating electrical field in the spaces on either side of said accelerator cage, said negative rotating electrical field means being of sufficient magnitude to impel a gas to ionize and also imparting a non-radial momentum upon said gas, a means for applying a potential to anode, anode a means for establishing an electrical field being of sufficient magnitude to influence rotating ion particles introduced in the spaces on either side of said accelerator cage, anode means being of positive potential with respect to said accelerator cage both said anode and said accelerator cage means being permeable to particle and gas flow.

2) The apparatus of claim 4 wherein said anode, said accelerator cage, and said cathode are generally spherical in shape, where said accelerator cage is concentrically located between said cathode and said anode, all are concentrically positioned with respect to each other.

3) The apparatus of claim 5 wherein said cathode is essentially an impermeable hermetically sealed metallic shell, and said accelerator cage as well as and said anode are self supporting conductive electrodes being permeable to ions and gas flow.

4) The apparatus of claim 6 wherein said accelerator cage means said gas is ionized and spherically rotated in the space on either side of said accelerator cage and is disposed on either side of said accelerator cage.

5) The apparatus of claim 6 wherein said anode is disposed inside space adjacent to said accelerator cage,
whereby ions within said gas are spiraled toward said volume inside said anode inside of said cathode shell.

6) The apparatus of claim 5 wherein said cathode shell having a vacuum pump connected by means of which the cathode shell can be evacuated and controlled quantities of said gas can be admitted thereto.

7) The apparatus of claim 4 wherein said apparatus having a means
whereby controlling coupling rotational energy transferred to a disk of sufficient size to accommodate a plurality of stud of equal size and length with a plurality of attached electrical conductor transferring electrical potential across a spatial gap to a plurality of stud of equal size and length attached to a stud plate delivering said electrical potential to a plurality of electrically conductive rod.

8) The apparatus of claim 6 wherein said anode being of a positive magnitude creating a negative potential corresponding to its field strength inside said anode space.

9) The apparatus of claim 6 wherein said accelerator cage creates a negative rotating electrical field causing the rotation of ions surrounding a negative potential inside said anode space creating a spherical rotating plasma ball thereof.

10.) A method of reducing neutron flux and or containing neutrons consequential of nuclear fusion reactions, comprising the steps of:
a.) generating ions while imparting said ions with a non-radial momentum while also conforming said ions to encompass said reactions by means of an accelerator cage in conjunction with an electrical switching apparatus as well as a virtual cathode, and
b.) colliding said ions with said neutrons also by said means,
whereby said neutrons are scattered and or absorbed by said ions.
